(19) United States
(12) Patent Application Publication
(10) Pub. No.: US 2011/0229397 A1
(43) Pub. Date: Sep. 22, 2011

(54) PROCESS AND APPARATUS FOR CONTINUOUS FLOW SYNTHESIS OF NANOCRYSTALS

(75) Inventors: Joseph Bartel, Eugene, OR (US); Lallie McKenzie, Eugene, OR (US)

(73) Assignee: LIFE TECHNOLOGIES CORPORATION, Carlsbad, CA (US)

(21) Appl. No.: 13/122,474

(22) PCT Filed: Oct. 2, 2009
(86) PCT No.: PCT/US09/59399

§ 371 Date: Jun. 2, 2011

Related U.S. Application Data
(60) Provisional application No. 61/102,642, filed on Oct. 3, 2008.

(51) Int. Cl. C01B 25/08; B01J 19/00

(52) U.S. Cl. 423/299; 422/129; 422/198; 422/240; 422/119; 257/E21.09

(57) ABSTRACT

Novel reactor, systems and methods of preparing nanocrystals in a continuous flow-through process are provided. The novel reactor is highly configurable and can be modified to achieve desired reaction times of a flow through mixture. The reactor is designed to provide uniform, efficient heating of the reaction mixture.

### CROSS REFERENCE TO RELATED APPLICATION

This application claims priority to U.S. Provisional Application No. 61/102,642, filed Oct. 3, 2008, the disclosure of which is incorporated herein by reference in its entirety.

### STATEMENT OF RIGHTS TO INVENTIONS MADE UNDER FEDERALLY SPONSORED RESEARCH

This work was supported in part by grants from the National Institute of Standards and Technology (NIST) Advanced Technology Program (ATP) and the US Commerce Department, grant number 70N.ANB4H3053. The U.S. government has certain rights in this invention.

### TECHNICAL FIELD

The present invention relates to apparatuses, systems, and methods relating to a novel reactor for continuous flow synthesis of nanocrystals. It provides for a configurable novel reactor capable of generating different sized nanocrystals through controlled reaction times.

### BACKGROUND ART

Semiconductor nanocrystals are minute crystals of semiconductor material that typically range in size from about 1 nm up to about 100 nm in largest dimension, often between 1 nm and 25 nanometers. The small size gives these materials unique optical properties that are intermediate between molecules and bulk matter. A variety of methods have been reported for the preparation of nanocrystals. These methods include inverse micelle preparations, arrested precipitation, aerosol processes, and sol-gel processes. A method commonly used for the preparation of binary nanocrystals is one in which one or more nanocrystal precursors, commonly a mixture of two such precursors, is injected into a hot solvent as the solvent is being stirred. Product nucleation can begin immediately, but the injection causes a drop in the solvent temperature, which tends to halt the nucleation process. Nucleation and particle growth can be continued by heating the reaction mixture with further stirring, and the reaction mixture can be cooled or diluted to stop the reaction when the desired particle size is obtained. As a result, the success of this batchwise “stirred-pot” method is strongly affected by system parameters such as the initial temperature of the solvent, the injection temperature and in particular the injection rate, the stirring efficiency, the concentrations of the reactant materials, the length of time that the mixture is held at the reaction temperature, and the efficiency of the cooling both after injection and after the desired endpoint is achieved. Some of these parameters are difficult to control with precision, and this can lead to poor reproducibility of the product. The lack of precise control can lead to nanocrystals with surfaces that are non-uniform, nanocrystals of varying sizes which results in broadening of the fluorescence emission band for a batch of nanocrystals, products that are readily degradable, and/or nanocrystals with low quantum yields. Additionally, investigations of the effects on these system parameters on the quality of the nanocrystal product is extremely labor intensive by stirred-pot methods. This is because every parameter that needs testing requires the preparation of a new batch of nanocrystals. Flow methods for making nanocrystals have been previously reported, as discussed above, but the apparatus designs used either fail to provide flexibility for rapid modification, do not adequately insure temperature control, or use heated liquids to control temperature, which is hazardous at the high temperatures needed for much nanocrystal chemistry. The limitations and difficulties described above and others encountered in the preparation of nanocrystals are addressed herein by providing an improved apparatus for the preparation of nanocrystals by continuous flow.

Flow synthesis of nanocrystals has many advantages over stirred-pot methods of nanocrystal synthesis. These advantages are described in several U.S. Pat. Nos. 6,682,596, 6,179,912, and 7,229,497. Previous flow reactor designs focused on preparing the highest quality nanocrystals at the expense of ease of use. Some examples of reactor designs previously described include fixed length tubes imbedded in a zinc or aluminum block, microfluidic channel reactors, and coiled tubing in hot oil baths. For both the fixed length tube in a metal block and microfluidic designs, to change the tube/channel diameter or length a new device must be fabricated. Although a coiled tube in a hot oil bath is reasonably easy to reconfigure, working with hot liquids (e.g. greater than 300° C. for most nanocrystal synthesis) can be potentially hazardous for the operator.

Various flow syntheses applicable to some small particulate products can be found in B. K. H. Yen, N. E. Stott, K. F. Jensen, M. G. Bawendi, Adv. Mater. 2003, 15, 1858; H. Wang, X. Li, M. Uehara, Y. Yamaguchi, H. Nakamura, M. Miyazaki, H. Shimizu, H. Maeda, Chem. Commun., 2004, 48; S. Krishnadasan, J. Tovilla, R. Vilar, A. J. deMello and J. C. deMello, J. Mater. Chem. 2004, 14, 2655; J. B. Edel, R. Fortt, J. C. deMello, A. J. deMello, Chem. Commun., 2002, 1136; E. M. Chan, R. A. Mathies, and A. P. Alivisatos, Nano Lett., 2003, 3, 199; X. Z. Lin, A. D. Terepka, H. Yang, Nano Lett., 2004, 4, 2227; E. M. Chan, A. P. Alivisatos, R. A. Mathies, J. Am. Chem. Soc., 2005, 127, 13854; K. Sue, K. Kimura, K. Arai, Materials Letters, 2004, 58, 3229; and H. Wang, H. Nakamura, M. Uehara, M. Miyazakia, H. Maeda, Chem. Commun., 2002, 1462.

For fixed length/diameter reactor designs, the flow velocity must be changed in order to change the residence time of the reaction mixture in the reactor. The ability to change the residence time without changing flow velocity is particularly advantageous for processes that are highly sensitive to flow velocity such as nanocrystal synthesis. In addition, there is a need to use flow synthesis to rapidly identify key reaction parameters for a given nanocrystal synthesis and optimize those parameters toward material performance requirements. Although this work has been performed successfully in the stirred-pot mode in the past, performing these experiments in stirred-pot mode can be extremely time consuming Traditional flow reactor designs proved to be too inflexible in terms of quickly changing the reaction zone diameter and length. The ability to quickly change the reaction zone dimensions is essential when using a flow device to study reaction parameters for novel nanocrystal preparations. There is a need for a configurable continuous flow reactor for use in research, development and the production environment where new processes for the synthesis of nanocrystals are constantly changing and novel nanocrystal materials are being developed.

### BRIEF SUMMARY OF THE INVENTION

Generally, the invention is directed to a novel reactor, a system comprising a novel reactor, and methods of use as it relates to the flow-through synthesis of nanocrystals. In general, the reactor comprises a thermally conductive reaction tube wound around and in contact with a thermally conductive elongated core. The reaction tube comprises a reaction channel through which a reaction mixture flows. The core and tubing is further encased in a thermally conductive sleeve which surrounds both the reaction tube and core and is in contact with or in close proximity to the reaction tube. Features of this novel reactor include the ability to modify the residence time of a reaction mixture by adjusting the channel length of the reaction tube without necessitating a change of flow velocity and without constructing a new reactor. For example, decreasing the pitch of the helical reaction tube winding results in an increase in length of the reaction channel (tube) and the corresponding residence time of a reaction mixture flowing through the reaction channel. On the other hand, increasing the pitch of the winding results in a decrease of overall reaction channel length within the reactor and a corresponding decrease in the residence time.

A method of synthesizing nanocrystals is also provided and comprises heating the reactor core and/or the reactor sleeve at a temperature sufficient to induce nanocrystal formation and flowing nanocrystal precursors through the subsequent heated reaction tubing. The design of the reactor provides controllable, stable and fast heating of the reaction mixture flowing through the reaction channel. The methods can be used to produce a core nanocrystal from suitable precursors, or to add additional layers to a nanocrystal core. Adding additional layers can include growing a nucleus of a nanocrystal core to a suitable size after nucleation has occurred either inside the reactor or externally, as well as growing a shell layer on a nanocrystal core.

It is also envisaged that multiple continuous flow reactors described herein could be used in series, wherein each reactor in series could be used to perform the same transformation, or a different transformation from the prior reactor. For example, a series of three reactors could be used, wherein the first reactor in series is used to produce core nanocrystal seeds, the second reactor in series is used to grow the seeds to provide core nanocrystals, and the third reactor in series is used to produce a shell on the core nanocrystals, thereby providing core/shell nanocrystals. In a specific example, it is envisaged that a series of three reactors could be used to prepare InP nanocrystal cores coated with a ZnS shell, essentially as described above.

In another embodiment, a reaction mixture could be processed through two reactors in series, thereby increasing residence time of a reaction mixture in the heated reactor zone. In a further embodiment, a first reactor could be used to produce and grow core nanocrystals, and a shell could be added in a second reactor. It will be clear to one of skill in the art that other configurations are possible, for example, to install an additional shell on a core/shell nanocrystal.

In one aspect, the a reactor for use in a continuous flow process is provided, comprising
i. a core, comprising an outer surface and a first and second end; and
ii. a sleeve, comprising an inner surface and a length;
wherein the core is positioned within the sleeve and the outer surface of the core and the inner surface of the sleeve are spaced apart by a gap distance along the length of the sleeve; and
iii. a reactor tube comprising a diameter, a wall, and an inner tube surface enclosing a reaction tube channel, wherein the diameter of the reactor tube is equal to or about equal to the gap distance; the reactor tube is formed into windings around the core for at least a portion of the length of the sleeve, and is in thermal contact with at least a portion of the outer surface of the core and optionally a portion of the inner surface of the sleeve along part of the length of the sleeve; the reactor tube further comprises a first and second end, wherein the first end of the reactor tube is an inlet in fluid communication with the tube channel, and the second end of the reactor tube is an outlet in fluid communication with the tube channel.

In another aspect, a reactor for use in a continuous flow process is provided, comprising
i. a reactor core, comprising an outer surface and first and second ends; and
ii. a sleeve, comprising an inner surface and a length, said sleeve enclosing a volume;

wherein the core is positioned within the enclosed volume of the sleeve, and the outer surface of the core and the inner surface of the sleeve are spaced apart by a gap distance along the length of the core; and
iii. a reactor tube comprising an outer diameter, a wall, an inner diameter, and an inner tube surface enclosing a reaction tube channel,
wherein the outer diameter of the reactor tube is less than or equal to the gap distance;
wherein the reactor tube is wrapped around the core for at least a portion of the length of the sleeve, and is in thermal contact with at least a portion of the outer surface of the core and optionally a portion of the inner surface of the sleeve along the length of the sleeve; and
iv. the reactor tube further comprises a first and second end, wherein the first end of the reactor tube comprises an inlet in fluid communication with the tube channel, and the second end of the reactor tube comprises an outlet in fluid communication with the tube channel. The reactor tube can be made of stainless steel. The volume enclosed by the sleeve can be cylindrical, and the gap distance can be substantially constant; the outer diameter of the reactor tube can be about the same as the gap distance; the core can be cylindrical. The first end of the reactor tube can be positioned near the first end of the core, and the second end of the reactor tube can be positioned near the second end of the core. The length of the sleeve can be at least as long as the length of the core, and reactor can comprise a means for heating a reaction mixture in the reactor tube. The reactor tube can provide turbulent flow of a reaction mixture in the reaction channel. The gap distance can be about equal to the outer diameter of the reactor tube, and the reactor tube can be at least as long as the core. In many embodiments, the core, sleeve and reactor tube are separate components and are adapted so they can be assembled to form the reactor and disassembled. The sleeve can comprise at least two separable pieces that join along the longitudinal axis of the sleeve to form a secure joint, wherein the separable pieces can be assembled around the core having the reactor tube wound around it to enclose the core.

In yet another aspect, a reactor for preparing an inorganic material is provided, comprising a reactor as described herein, wherein the inorganic material comprises a semiconductor nanocrystal. The reactor can house a reaction mixture containing one or more nanocrystal precursors in the reaction channel.

The reactor provided herein provides a very flexible design that can be modified in many parameters as described herein while being capable of providing a stable temperature environment for a chemical reaction that occurs inside the reactor tube. The primary purpose of the design is for use with a heated reaction, for which the design provides multiple factors that contribute to a stable operating temperature for the reactor tube and its contents. In some embodiments, the core and/or sleeve are thermostatically maintained at a desired temperature, typically both at the same temperature, thereby maintaining a uniform temperature along the length of the reactor tube where it resides inside the reactor. In one embodiment, the helical winding comprises stainless steel tubing. In another embodiment, the reactor comprises a means for changing the residence time of a reaction mixture in the helical reaction channel. In other embodiments, the reactor comprises a means for heating the reaction mixture in the reactor, and optionally at least one temperature sensing device to monitor the temperature of at least one portion of the core, the sleeve, or both. In some embodiments, the helical winding provides a means for turbulent flow of the reaction mixture in the reaction channel. In many embodiments, the core, sleeve and helical structure are modular, separate units, and can be repeatedly assembled to form the reactor and disassembled for convenient changing of the length of the helical winding.

In other aspects, a system for a continuous flow process for the production of an inorganic compound is provided, comprising
i. at least one reactor described herein;
ii. at least one reservoir for supplying a reaction mixture to the reaction channel; and
iii. a means for collecting the reaction mixture at the outlet.

The reactor of the system can includes a means for heating or at least one sensor, wherein the sensor is used to monitor a property of the reaction mixture. The means for collecting the reaction mixture can include a a diverter, wherein the diverter comprises a section of the flow path after the reactor. At least the reactor can be surrounded by an inert atmosphere.

In some embodiments, the reaction mixture collected from the outlet of one reactor may be added to the inlet another reactor. The reaction mixture can be collected at the outlet of the first reactor and manually added to a second reactor, or the two reactors can be connected in series such that the outlet of the first reactor is directly connected to the inlet of the second reactor and no intermediate isolation of the reaction mixture from the first reactor is required.

In some embodiments, the reactor of the system further comprises a means for heating the core, or the sleeve, or both. It optionally also includes one or more temperature sensing devices. In some embodiments, at least one temperature sensing device is provided for the sleeve.

In other aspects, a method of producing nanocrystals in a continuous flow process is provided, comprising introducing at least semiconductor nanocrystal precursors into a reactor channel as described herein, at a temperature sufficient to induce formation of a semiconductor nanocrystal.

In yet another aspect, a method of producing nanocrystals in a continuous flow process is provided, comprising introducing a reaction mixture comprising one or more semiconductor nanocrystal precursors into the reactor channel, and causing the reaction mixture to flow through the reactor tube, while the reactor tube is heated to a temperature sufficient to induce formation of a semiconductor nanocrystal. The reaction mixture can include at least one saturated precursor in at least one saturated solvent (e.g., a saturated solvent that includes at least one saturated hydrocarbon, saturated alkylamine, saturated carboxylic acid, or saturated fluorinated solvent, and each saturated hydrocarbon, saturated alkylamine, saturated carboxylic acid, or saturated fluorinated solvent comprises at least 4 carbon atoms). The solvent can comprise, e.g., squalane and/or decylamine. The precursor can comprise a stearate salt. The nanocrystal can be, for example, InP or InAs.

In some embodiments, a saturated and/or unsaturated hydrocarbon is used as a solvent carrier. In certain embodiments, the solvent carrier is preferably a hydrocarbon having at least four carbon atoms, preferably at least eight or ten carbon atoms. Shorter hydrocarbons may be useful at lower reaction temperatures and/or higher reaction pressures. In some embodiments, the use of a saturated hydrocarbon solvent is preferred. Under certain conditions, unsaturated hydrocarbons may undergo polymerization under the reaction conditions; however, unsaturated hydrocarbons can be used at temperatures below which polymerization becomes problematic. In certain embodiments, the method further comprises reacting at least one saturated precursor in at least one saturated solvent.

In another aspect, a method of producing nanocrystals in a continuous flow process is provided, comprising introducing nanocrystal precursors into a system described herein; and heating the reactor to a temperature sufficient to induce nanocrystal formation. Preferably, the temperature of the helical winding and the reaction mixture it contains is substantially constant along the portion of the helical winding that is in contact with the reactor core. In some embodiments, a constant temperature suitable for nanocrystal formation is established in the helical winding or in the reactor core before nanocrystal precursors flow through the helical winding.

In another aspect, a method to produce variable sized nanocrystals in a continuous flow process is provided, comprising any one of the methods provided herein and further including modifying the length of the reaction channel that is in the reactor. Modifying the length of the reaction path changes the length of time for which the nanocrystal precursors are maintained at a sufficient temperature to support nanocrystal growth; as a result, changing the length of the reaction channel can be used to change the size of the nanocrystals by modifying the duration of nanocrystal growth. In some embodiments, the method to produce variable sized nanocrystals in a continuous flow process further comprises disassembly of the reactor, wherein the sleeve, core and winding are separated and each optionally replaced or modified. Modification of the length of the reaction channel can include replacing the reactor tube with a shorter or longer reactor tube. For example, the reactor tube can be replaced with a reactor tube of a different inner diameter.

Conventional methods for nanocrystal production often use unsaturated precursors. The present reactor can be used with standard unsaturated precursors. Alternatively, saturated precursors can be used. Certain embodiments use at least one unsaturated precursor in the production process. In one aspect, a method of producing a core nanocrystal is provided, comprising reacting a chalcogen precursor dispersed in decylamine or a similar saturated alkylamine, with a metal stearate or a similar saturated metal carboxylate salt, in squalane or a similar saturated hydrocarbon solvent, at a temperature sufficient to induce formation of a nanocrystal core. In another aspect, a method of producing a core/shell nanocrystal is provided, comprising reacting a chalcogen precursor dispersed in decylamine or a similar saturated alkylamine, with a metal stearate or a similar saturated metal carboxylate salt in squalane or a similar saturated hydrocarbon solvent, at a temperature sufficient to induce formation of a shell layer on the surface of a pre-formed nanocrystal core. The present reactor can be used to prepare any type of nanocrystal core and/or shell. For example, the reactor can be used to prepare a CdSe or InP core. In certain embodiments, the method is used to provide an InP core nanocrystal, and to further provide an InP/ZnS core/shell nanocrystal. In other embodiments, the reactor is used to provide an CdSe core nanocrystal, and to further provide an CdSe/ZnS core/shell nanocrystal.

In yet another aspect, a method to optimize conditions for producing nanocrystals with a flow reactor is provided, comprising:
i) using the method of claim 21 to produce a nanocrystal;
ii) assessing the nanocrystal to determine whether it has a desired property;
iii) modifying at least one reaction parameter selected from residence time, ratio of nanocrystal precursors, concentration of nanocrystal precursors, and reactor temperature;
iv) producing a nanocrystal with the new reaction parameters; and
v) repeating the assessment and modification steps if necessary until a nanocrystal having the desired property is produced.

### BRIEF DESCRIPTION OF THE DRAWINGS

FIG. 1 illustrates (1A) a partially assembled reactor, including a two-piece sleeve disposed around a cylinder, which is the reactor core, wound with reactor tubing; additional reactor tubing, an additional core, and an end cap are also shown; (1B) a view of one end of a disassembled reactor, showing its core wrapped with stainless steel tubing and an end cap; and (1C) a lengthwise view of a portion of the sleeve, showing how reactor tubing is wound around a reactor core, and also showing a groove at either end of the outer surface of the core.

FIG. 2 illustrates an embodiment of the reactor sleeve which comprises two separable parts capable of transferring heat from a heat source, such as an external heater or heater tape The reactor sleeve includes a top portion (A) and a bottom portion (B). The sleeve includes grooves that, when assembled, provide openings for reactor tubing to lead into and out of the reactor, and a groove to provide a well into which a thermocouple can be inserted to monitor the temperature of the reactor sleeve. The two separable parts are designed for easy assembly around a reactor core having a reactor tube wrapped one or more times around the core.

FIG. 3 shows a schematic of an embodiment of a flow through system. The solid lines represent fluid flow paths that may be included, and the dashed lines represent some of the electrical or electronic control and information paths.

FIG. 4 shows the absorbance wavelength of output from a reactor, recorded over time, for an InP synthesis reaction, and demonstrates that particle absorbance wavelengths are within a narrow range when produced with a reactor as described herein.

FIG. 5 shows the absorbance spectra of InP nanocrystals synthesized batch-wise and the collection of InP nanocrystals that were synthesized continuously for over 1 hour by the novel flow through reactor system.

FIG. 6 shows interaction plots resulting from varying the temperature, residence time, and the In:P mole ratio in the continuous flow synthesis with the novel reactor. FIG. 6A shows the effect of temperature and residence time on the absorbance wavelength at a constant In:P mole ratio. FIG. 6B shows the effect of temperature and In:P mole ratio on absorbance wavelength at constant residence time. FIG. 6C shows the effect of residence time and In:P mole ratio on absorbance wavelength at a constant reaction temperature.

FIG. 7 shows the absorbance spectra of InP nanocrystals synthesized with the novel flow through reactor system for data points shown in FIG. 6C. InP nanocrystals made by varying reaction parameters (i.e., residence time for the reaction mixture in the heated reactor zone and In:P molar ratios) exhibit absorbance peak maxima ranging from about 450 nm to about 550 nm.

FIG. 8 shows photographs of (8A) a partially assembled reactor, including a two-piece sleeve disposed around a cylinder, which is the reactor core, wound with reactor tubing; additional reactor tubing, an additional core, and an end cap are also shown; (8B) a view of one end of a disassembled reactor, showing its core wrapped with stainless steel tubing and an end cap; and (8C) a lengthwise view of a portion of the sleeve, showing how reactor tubing is wound around a reactor core, and also showing a groove at either end of the outer surface of the core.

### MODES OF CARRYING OUT THE INVENTION

The process and apparatus provided herein can be understood more readily by reference to the following detailed description of the preferred embodiments of the invention and the Examples included herein. It is to be understood that the terminology used herein is for the purpose of describing specific embodiments only and is not intended to be limiting.

Unless defined otherwise, all technical and scientific terms used herein have the same meaning as is commonly understood by one of ordinary skill in the art to which this invention belongs.

The discussion of the general methods given herein is intended for illustrative purposes only. Other alternative methods and embodiments will be apparent to those of skill in the art upon review of this disclosure.

As used herein, “a” or “an” means “at least one” or “one or more.”

As used herein, ‘about’ means that the numerical value is approximate and small variations would not significantly affect the practice of the invention. Where a numerical limitation is used, unless indicated otherwise by the context, ‘about’ means the numerical value can vary by ±10% and remain within the scope of the invention.

A group of items linked with the conjunction “or” should not be read as requiring mutual exclusivity among that group, but rather should also be read as “and/or” unless expressly stated otherwise. Although items, elements, or components of the invention may be described or claimed in the singular, the plural is contemplated to be within the scope thereof unless limitation to the singular is explicitly stated.

“Nanoparticle” as used herein refers to any particle with at least one major dimension in the nanosize range. Typically, a nanoparticle has at least one major dimension ranging from about 1 nm to 1000 nm.

Examples of nanoparticles include a nanocrystal, such as a core/shell nanocrystal, plus any tightly-associated organic coating or other material that may be on the surface of the nanocrystal. A nanoparticle may also include a bare core/shell nanocrystal, as well as a core nanocrystal or a core/shell nanocrystal having a layer of, e.g., TOPO or other material that is not removed from the surface by ordinary solvation. A nanoparticle may have a layer of ligands on its surface which may further be cross-linked; and a nanoparticle may have other or additional surface coatings that modify the properties of the particle, for example, solubility in water or other solvents. Such layers on the surface are included in the term ‘nanoparticle.’

“Nanocrystal” as used herein refers to a nanoparticle made out of an inorganic substance that typically has an ordered crystalline structure. It can refer to a nanocrystal having a crystalline core, or to a core/shell nanocrystal, and may be 1-100 nm in its largest dimension, preferably about 1-50 nm in its largest dimension.

A core nanocrystal is a nanocrystal to which no shell has been applied; typically it is a semiconductor nanocrystal, and typically it is made of a single semiconductor material. It may be homogeneous, or its composition may vary with depth inside the nanocrystal. Many types of nanocrystals are known, and methods for making a nanocrystal core and applying a shell to it are known in the art. The nanocrystals provided using the flow reactors described herein are frequently core nanocrystals. In some embodiments, core/shell nanocrystals are provided. Nanocrystals generally require a surface layer of ligands to protect the nanocrystal from degradation in use or during storage.

“Quantum dot” as used herein refers to a nanocrystalline particle made from a material that in the bulk is a semimetal (e.g., a material such as bulk HgSe that can become a semiconductor when appropriately sized), semiconductor or insulating material, which has a tunable photophysical property in the near ultraviolet (UV) to far infrared (IR) range.

A flow reactor can be used to prepare a size plurality of colloidal semiconductor nanocrystals by a continuous flow method. The continuous flow method produces samples with size distributions and quantum efficiencies comparable to those prepared in conventional batch processes.

In a continuous flow system, reactions are performed at steady state, making it possible to achieve better control and reproducibility. Further benefits can be realized by scaling down the reactor dimensions to micrometers, thereby reducing the consumption of reagents during the optimization process and improving the uniformity of temperature and residence times within the reaction volume. Continuous flow methods require careful control to ensure uniformity, but provide greater operating efficiencies (e.g., they require less operator intervention) and can produce larger amounts of product and offer greater reproducibility than batch processing.

A reactor is provided for use in a continuous flow process, comprising
i. a reactor core, comprising an outer surface and first and second ends;
ii. a sleeve, comprising an inner surface and a length, said sleeve enclosing a volume;
wherein the core is positioned within the enclosed volume of the sleeve, and the outer surface of the core and the inner surface of the sleeve are spaced apart by a gap distance along the length of the core; and
iii. a reactor tube comprising an outer diameter, a wall, an inner diameter, and an
   inner tube surface enclosing a reaction tube channel;
   wherein the outer diameter of the reactor tube is less than or equal to the gap distance;
   wherein the reactor tube is wrapped around the core for at least a portion of the length of the sleeve, and is in thermal contact with at least a portion of the outer surface of the core and optionally a portion of the inner surface of the sleeve along the length of the sleeve; and
   the reactor tube further comprises a first and second end, wherein the first end of the reactor tube comprises an inlet in fluid communication with the tube channel, and the second end of the reactor tube comprises an outlet in fluid communication with the tube channel.

This reactor design permits easy assembly and disassembly and replacement of the reactor tube as a way to adjust flow speeds and residence times, and it provides a reliable method to maintain a suitably constant reaction temperature for the reactor tube. Maintaining a stable temperature is important for highly sensitive chemical processes, including nanocrystal formation: variations in temperature will cause changes in particle size or quality, which would be detrimental to nanocrystal products because the particle size directly affects fluorescence wavelengths. If the particle size varies during a run with a flow reactor, for example, the product will not be desirably monodisperse.

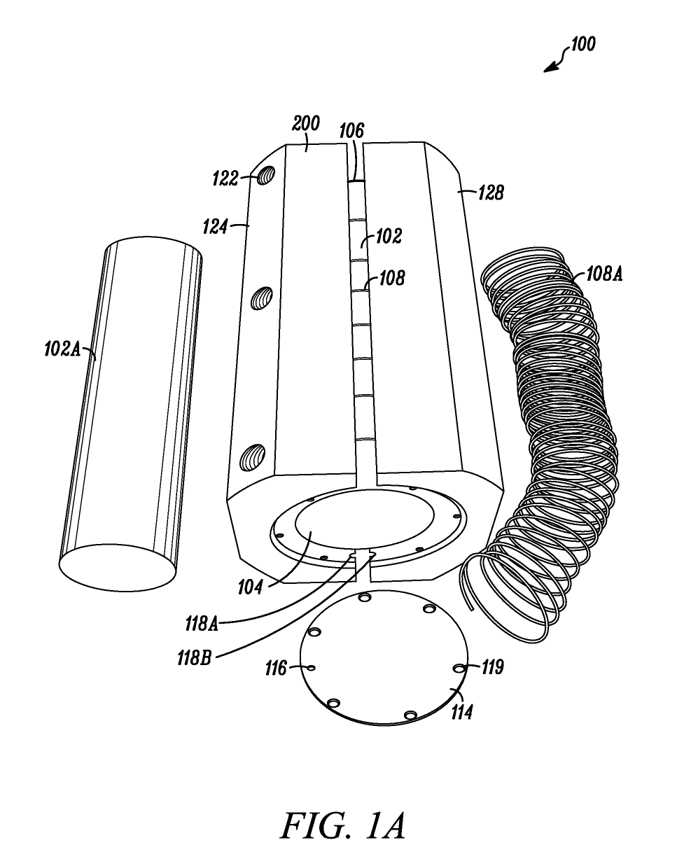

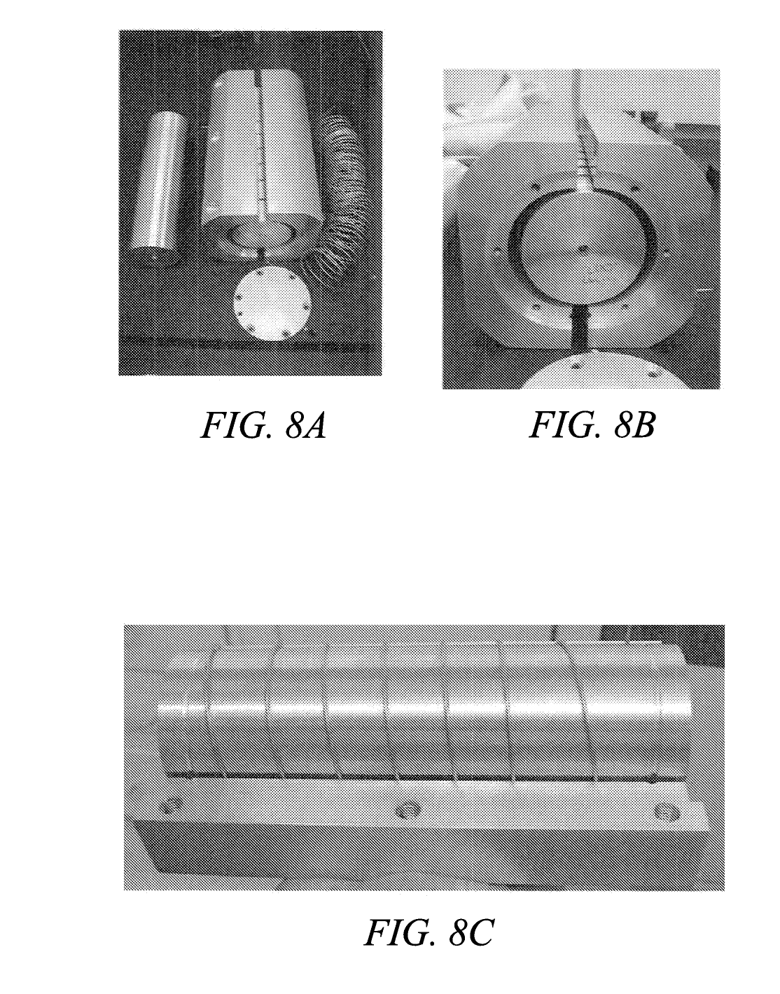

Referring to FIGS. 1A-1C and 8A-8C, a continuous flow reactor 100 is shown having a reactor core 102 (shown separately as 102A) that includes an elongated material with a diameter and a first end 104 and a second end 106. In some embodiments, the core has an overall, general shape that is cylindrical. Its precise shape is not critical, as long as its contours are compatible with those of the sleeve, but in many embodiments it provides a smoothly curved outer surface to promote effective thermal contact with the reactor tube. In some embodiments, the core has an overall, general shape that is cylinder-like, for example, wherein the ends of the cylinder are not necessarily flat, or wherein the cylinder like shape has one or more bends or twists, or wherein a section of the length of the core has one or more narrow necks or a combination thereof.

The average diameter of the core can be selected to suit a particular application of interest, taking account of flow volumes needed, fluid characteristics such as viscosity, and materials used for the reactor tube. The reactor core can have any length or diameter. For example, the core can have a largest diameter from about 0.1-250 cm, 0.1-100 cm, 0.1-75 cm, 0.1-50 cm, 0.1-40 cm, 0.1-30 cm; 0.1-20 cm; 0.1-10 cm; 0.1-9 cm; 0.1-8 cm; 0.1-7 cm; 0.1-6 cm; 0.1-5 cm; 0.1-4 cm; 0.1-3 cm; 0.1-2 cm; 0.1-1 cm; 1-10 cm; 1-25 cm; 1-50 cm, 1-100 cm, 2-8 cm; 3-7 cm; or 1-5 cm . The length of the core can be about 1-1000 cm, 1-500 cm, 1-250 cm, 1-100 cm; 30-90 cm; 1-50 cm; 1-40 cm; 1-30 cm; 1-25 cm; 1-20 cm; 1-15 cm; 1-10 cm; 1-5 cm; 5-75 cm; 10-50 cm; 10-30 cm or 20-30 cm. The diameter of the core can vary along the length of the core, but in many embodiments, the diameter of the core is essentially constant along the length of the core.

The core 102 provides a support for the reactor tube 108 to form windings that are wrapped around the core along at least a portion of the length of the core, wherein the windings are in thermal contact with the surface of the core. The coiled reactor tube is shown separately as 108A. In some embodiments, the core is important in transmitting heat to the reactor tube and it optionally comprises a means for heating, such as a heating cartridge, that heats the core to a temperature sufficient to induce nanocrystal formation in the reactor tube which is wound along at least a portion of the length of the core. In some embodiments, the core further comprises a groove, well, or opening adapted for receiving a thermocouple, or includes at least one temperature measuring device that can be used to monitor the temperature of the reactor prior to or during use. Suitable temperature measuring devices are well known, and include thermocouples, thermometers, IR sensors, and the like.

In certain embodiments, the core may further comprise one or more grooves and/or ridges in or on the outer surface of the core. In the design depicted in FIG. 1C, the core further comprises grooves 110 and 112 on the outer surface at either end of the core, which may be used to secure the reactor tube or to guide the tube through a sleeve 200. In certain embodiments, these grooves and/or ridges can have a helical pattern winding around the length of the core. The grooves and/or ridges provide a guide for the reactor tube to form windings around the core for at least a portion of the length of the core and/or provide additional thermal contact between the reactor tube and the core. The grooves and/or ridges may cover at least about 20, 40, 60, 80 or 100% of the length of the core. However, grooves are not essential, and suitable embodiments include those wherein the core has a substantially smooth outer surface along at least 20, 40, 60, 80 or 100% of its length and has constant or nearly constant cross-sectional shape and dimensions along its length. In some embodiments, the cross-sectional shape of the core perpendicular to its axis is circular.

The ends of the core (104, 106) may be the same or different, and are not typically in close contact with the reactor tube, so their shape is not critical. The core may be solid or hollow, and the ends may thus be open or closed. One or both ends may be adapted to accommodate a temperature measuring device to monitor the temperature of the core, and they may be adapted to receive a heating device such as a resistive heater, or more than one such heating device and/or temperature measuring device.

The core may be made of any suitable material, such as metal, glass, silica, ceramic, and composite materials. In many embodiments, the core is made of a heat-conductive material to facilitate heat transfer, such as a metal. In some embodiments, the core comprises sufficient material to permit it to function as a heat sink, and to be a source of thermal inertia to help maintain the reactor tube at a desired, substantially constant temperature. Temperature control for a flow reactor is critical, since the material flowing through the reactor can carry heat energy away, thus cooling the reactor; the present design uses the core and/or sleeve as heat sinks that help maintain a stable, substantially constant temperature during operation.

By stable or substantially constant temperature is meant a temperature that does not vary by enough to adversely affect the product provided by the reactor. In some embodiments, this means the temperature can be maintained within ±5° C. or within ±2° C., preferably within ±1° C., more preferably within ±0.5° C., most preferably within ±0.25° C., under normal flow operations over a period of at least an hour. Note that the temperature may not be the same throughout the reactor, but the temperature at points within or adjacent to the reactor tube should be maintained at a stable value to provide a product that is consistent in size and quality.

Referring to FIGS. 1A-1C, a sleeve structure 200 surrounds at least a portion of the core and the reactor tube wound around the core, and comprises a first and second end. In some embodiments, the sleeve surrounds at least about 50, 60, 70, 80, 90, or 99% of the length of the core, or it may surround the entire length of the core, and it can also extend beyond the core, so that the core is surrounded along its entire length by the material of the sleeve. In some embodiments, the length of the sleeve is about 1-1000 cm, 1-500 cm, 1-250 cm, 1-100 cm; 30-90 cm; 1-50 cm; 1-40 cm; 1-30 cm; 1-25 cm; 1-20 cm; 1-15 cm; 1-10 cm; 1-5 cm; 5-75 cm; 10-50 cm; 10-30 cm; or 20-30 cm.

The sleeve can be a metal block of aluminum, which has been bored out such that a cylinder (core) of solid aluminum will fit inside. Sufficient space around the cylinder is provided so that a coil of tubing (a reactor tube) can be wrapped around the cylinder such that when the cylinder, tubing and block are assembled, the tubing is in thermal contact with both the cylinder and the block. This design allows for different length of tubing to be used with the same reactor. Different diameters of cylinders can be fabricated to accommodate tubing with different outer diameters. Holes in the aluminum block accommodate thermocouples for temperature measurement and allow the tubing to pass into and out of the reaction chamber. In some embodiments, the sleeve and/or the core comprise a heating element or a well, cavity or opening to permit insertion of a heating device.

In some embodiments, the sleeve surrounds almost the entire core, optionally including the ends of the core. However, the sleeve provides at least one or more ports or grooves, to provide at least an inlet and outlet for the reactor tube. The inlet and outlet portions of the sleeve can be adapted to permit the reactor tube to pass through the sleeve into the volume inside the sleeve and back out of the volume inside the sleeve via a single opening, but in many embodiments the reactor tube passes through separate openings in the sleeve, i.e, it enters the sleeve via one opening near the first end of the core, and exits the sleeve at a second opening that is near the second end of the core. The ports or grooves in the sleeve thus comprise a first and second opening through the material of the sleeve, and permit the entry and exit of tubing between the interior and exterior of the sleeve. Certain sleeve embodiments include a hole for a thermocouple or a heater cartridge. Alternatively, the sleeve can be heated using an external heater source, such as heater tape.

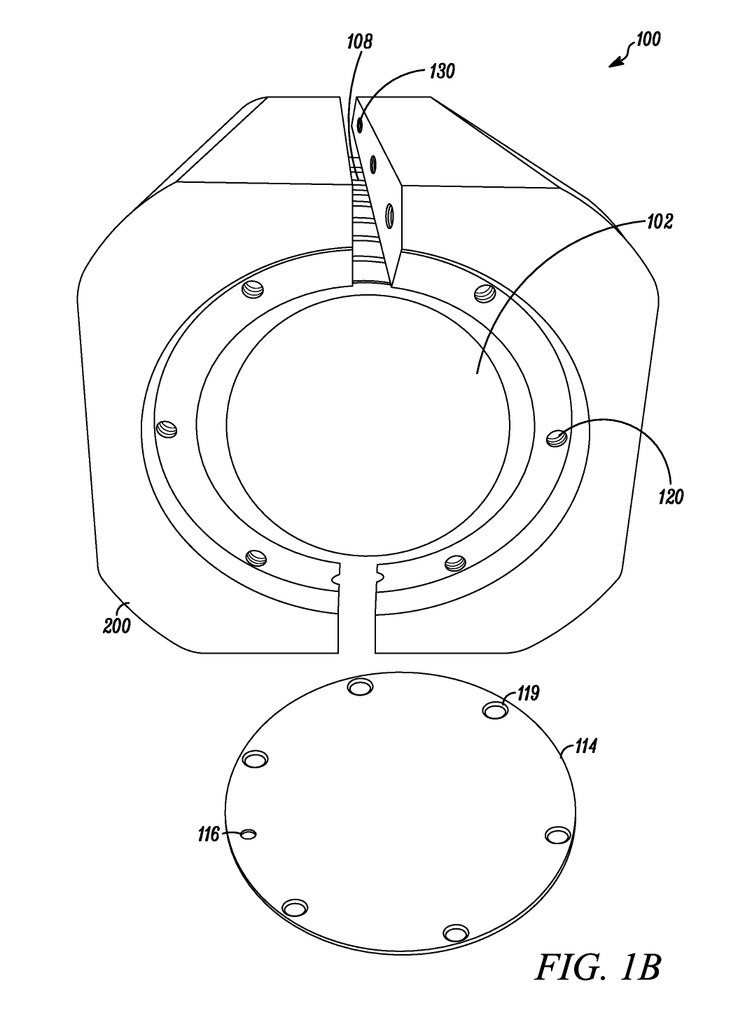

Referring to FIG. 2, an exemplary reactor sleeve is shown having separable top 208 and bottom 210 portions, where each portion has a first end 202 and a second end 204. Each portion of the sleeve has an inner surface 206 that defines a volume into which a reactor core fits. The reactor core having reactor tube wrapped around it should fit within the sleeve when the reactor is assembled, and preferably it will fit snugly within the sleeve, meaning the sleeve is in contact with at least part of the reactor tube, while the core is also in contact with at least part of the reactor tube. Each portion includes a groove 212 sized to accommodate a thermocouple, a groove 214 for entry tubing (e.g., 1/16″ OD SS tubing) and a groove 216 for exit tubing. Top and bottom portions (208, 210) of the reactor sleeve also can include one or more holes 218 for screws to attach top 208 and bottom 210 reactor sleeve portions.

In some embodiments, at least one port/groove in the sleeve is located near each of the first and second ends of the core and/or sleeve. In other embodiments, at least one port/groove in the sleeve is located anywhere along the length of the sleeve, or at least one port/groove is located near each inlet and outlet of the reactor tube.

In some embodiments, the sleeve has a generally cylindrical interior (volume), like the inside of a tube (e.g., form of a half-pipe). The interior of the sleeve is shaped to accommodate a reactor core wound with a reactor tube, thus its shape and size can be selected according to the core and reactor tube it must accommodate. Typically, the sleeve, once assembled, will have a generally smooth interior with a substantially circular cross- section along its length that remains substantially constant along the length of the sleeve, like the interior of a straight section of pipe.

The diameter of the open interior cross-section of the sleeve is approximately equal to or slightly larger than the sum of the outer diameter of a core to be used plus twice the outer diameter of a reactor tube to be used. If the core varies in cross-sectional size or shape along its length, the interior surface of the sleeve can optionally be similarly varied in order to allow the gap distance between core and sleeve to be essentially constant.

Sized in this way, a reactor tube having an external diameter of x can be wound around a core having an external diameter of y at a particular point along the length of the core, and the outer dimension of the combination will be approximately 2x+y (twice the reactor tube diameter plus the reactor core diameter) at that point; thus a sleeve having an open interior volume with a circular cross-section having an inner diameter of 2x+y will fit snugly around the reactor core plus reactor tube wrapped around the core at that point. This interior dimension can be larger than 2x+y, but is of about this dimension in some embodiments, so that the sleeve is in effective thermal contact with the reactor tube. By making effective thermal contact with the reactor tube, the sleeve can be heated to a desired temperature and can provide thermal inertia to hold the reactor tube at the desired temperature. In specific embodiments, the reactor tube is wrapped tightly around the core and the sleeve fits snugly around the combined core plus reactor tube along most of the length of the core, so the core and sleeve both make thermal contact with the reactor tube along at least most of the length of the reactor core. One or both of the core and sleeve can then be heated in order to maintain effective heat transfer and thermal stability to the reactor tube.

In some embodiments, the sleeve length is about the length of the core, and the sleeve can also comprise optional endcaps located at each end of the reactor. Each endcap comprises a means for attachment to the core and/or the sleeve, such as a screw, clip, bolt, or adhesive. Referring to FIGS. 1A and 1B, for example, an endcap 114 can include a set of holes 119 configured to receive a screw or bolt. The sleeve 200 can include a set of holes 120, which can be threaded, that match the size and alignment of holes 119 such that the screws or bolts can join the endcap to the sleeve. Each side of the reactor sleeve 200 includes a groove 118A and 118B that together form a port in the reactor sleeve. Each endcap can optionally comprise a hole or port 116 that can be aligned with the port formed by joining grooves 118A and 118B for the entry or exit of the reactor tubing or for insertion of a thermocouple. The endcaps can be considered part of the sleeve, and the openings for ingress and egress of the reactor tube can be in one or both endcaps. In certain embodiments, the tubing can be directed out through the endcap. Alternatively, the tubing can exit the reactor through a hole in the sleeve to avoid bending the tubing. In some embodiments, the sleeve comprises means for heating the sleeve and/or the reactor tube to a temperature sufficient to induce nanocrystal formation in the reactor tube. In some embodiments, the sleeve further comprises a groove, slot, or opening for a thermocouple or other temperature measuring device.

In certain embodiments, the sleeve comprises one or more grooves and/or ridges in or on the inner surface of the sleeve. In certain embodiments, the core further comprises a groove on the outer surface at each end of the core which may be used to secure the reactor tube or to guide the tube through the sleeve. In specific embodiments, the groove at each end of the core is located adjacent to the hole in the sleeve where the tube comes out through the sleeve.

In some embodiments, the sleeve comprises at least two pieces that i.) can be disassembled and reassembled and ii.) separate and join along the length of the sleeve, such as along a longitudinal axis of the sleeve, to form an immovable joint, that can still be disassembled. In further embodiments, upon assembly, the sleeve optionally forms a continuous seal along the joint; however, a tight seal is not essential to the operation of the sleeve. Most importantly, the sleeve design permits disassembly of the sleeve to yield access to the core and reactor tube, wherein either component may be replaced and/or wherein the reactor tube can be modified, followed by reassembly of the sleeve surrounding the modified interior. Optionally, the separate pieces are shaped or adapted so they can be assembled around a core having reactor tube wrapped around the core; for example, the sleeve can be fashioned as a large tube shape sized to fit around a ‘core plus reactor tube’ assembly, and the sleeve can then be bisected along its axis into approximately equal halves so that the two halves can be assembled around the ‘core plus reactor tube’ assembly (see FIG. 1). Alternatively, in some embodiments, the sleeve may be removable by sliding the core plus reactor tube out of one end of the sleeve, rather than having the sleeve made of separable components.

A representative, fully fabricated embodiment of a reactor system is shown in FIGS. 1A-1C. The sleeve design is essentially the same as in the drawings from FIG. 2 with some modifications made for the purpose of ease in fabrication and use. Modifications include the position of the holes for the tubing in relation to the cylinder, and the addition of detachable endcaps. In certain embodiments, cylinders (reactor cores) can be fabricated such that the reactor can accommodate tubing with outer diameters of either ⅛ inch or 1/16 inch. For example, one core is sized to fit snugly in the block (sleeve) when ⅛^{th} inch tubing is wrapped around it, and the other core is sized to fit snugly in the block when 1/16^{th} inch diameter tubing is wrapped around it. The length of tubing is easily changed to allow for longer residence times at a constant flow velocity, and even changing tubing size only requires the user to change the core.

The sleeve may also be made of any suitable material, and like the core, it is often made of a thermally conductive material to promote effective heat transfer to the reactor tube. A metal such as aluminum can be used for the sleeve. Preferably, the sleeve comprises a sufficient amount of material to provide enough thermal inertia (heat capacity) to maintain a stable operating temperature during use of the flow system.

The reactor tube is a tubing or similar material that provides the flow path for reaction mixtures that are used in the flow reactor, and must be made of material compatible with the reaction mixtures of interest. The reactor tube typically winds around at least a portion of the length of the core and is in thermal contact with at least the core. Thermal contact refers to solid bodies in contact and capable of conducting heat between at least the two bodies, preferably with high efficiency. Thermal conductance is influenced by many factors, including surface roughness, contact pressure and contact surface area between the bodies, as well as the material the bodies are made of. In some embodiments, the reactor tube is wound tightly around the core such that the majority of the tube maintains continuous contact with the outer surface of the core, provided that the reactor tube can still be disassembled from the core.

The tube is made of material that is thermally conductive in order to permit efficient heat transfer between the heat source(s) in contact with the tube and the reaction mixture flowing through the tube. The tube can be made of material such as stainless steel or glass that will be unreactive toward the reaction mixture, or it is at least lined along its inner tube surfaces with such an inert material.

The core and/or sleeve provide heat sources that can be in contact with the reaction tube to help keep it at a constant desired temperature. As discussed before, control of temperature is critical in nanocrystal formation, because it is directly related to maintaining a desired rate of nanocrystal formation or growth: Without wishing to be bound by theory, nucleation is thought to occur, for example, when a solution is supersaturated with nanocrystal components, where the saturation point is strongly dependent upon temperature in most cases. Thus in one aspect, the an efficient means is provided to maintain a desired temperature in a reaction mixture flowing through a reaction tube, by using the reactor designs described herein to bring the core and/or sleeve in thermal contact with the reaction tube in a zone where nanocrystal formation is desired to occur. The efficiency of the heat transfer is also dependent on the internal diameter and wall thickness of the tube and on the composition of the heat transfer media in contact with the tube.

In some embodiments, the reactants can be preheated outside the reaction tube and combined prior to entry into the tube. In other embodiments, the reactants may be mixed prior to entering the reactor described herein, and may optionally be pre-heated prior to entering the reactor. Where desirable, the reactor can comprise additional features that permit additional reagents to be added to the mixture after it enters the reactor; for example, it may be desirable to add more of a nanocrystal precursor after the nanocrystal formation begins, in order to maintain a suitable reaction rate. It may also be desirable to add a reducing or oxidizing agent to the reaction mixture after it has been heated, in order to facilitate nucleation and growth of a nanocrystal. It may also be desirable to add more solvent or a diluent to the reaction mixture, for example after nucleation has occurred, to prevent further nucleation while maintaining a temperature that supports a desirable rate of growth of new layers on existing nucleated particles.

While it is not intended to be limited to specific values for the diameter and length of the tube, the optimal values of these dimensions will be determined by considering the viscosity of the reaction mixture and the pressure drop needed to drive the reaction mixture through the tube, both of which will depend on the concentration of the reactants in the reaction mixture, the temperature, and other parameters. Desirable flow characteristics for a particular reaction system, such as a desire to produce either laminar or turbulent flow, are also factors in sizing of the components. The optimal dimensions can be determined by routine experimentation, or by the use of relationships that are well known among those skilled in fluid dynamics. The choice of the tube dimensions, for example, will depend on the desired flow rate and temperature as well as other parameters of the system, and in combination with the characteristics of the flowing medium, these will determine whether flow is turbulent or laminar. In some embodiments, the size, shape or composition of the reactor tube contribute to providing turbulent flow to facilitate mixing of the reaction mixture.

The length of the reactor tube can be selected to suit a particular application of interest, taking account of flow volumes needed, fluid characteristics such as viscosity, and materials used for the reactor tube. The length of the reactor tube is typically at least as long as the core, and in some embodiments it is at least twice the length of the core, or at least 1.5 times the length of the core, in order to permit the reactor tube to wrap around the core inside the reactor. In some embodiments, the reactor tube will be from about 1-2000 cm in length, about 1-1500 cm in length, about 1-1000 cm in length, about 1-500 cm in length, about 1-250 cm in length, about 1-100 cm in length, about 1-50 cm in length, about 1-20 cm in length, about 1-10 cm in length, about 10-500 cm in length, or about 20-200 cm in length. However, other lengths are possible depending on the specific application of interest.

Efficient heat transfer into the fluid stream is desirable, because it permits the temperature of the fluid stream to be kept relatively constant. Constant and reliable temperature control is important in most flow reactor applications, and is especially important in the embodiments of the reactor and systems that are used to make nanocrystals. The size and quality of nanocrystal products can be adversely affected by inconsistent temperatures, thus temperature control is an important aspect of the reactor systems described herein. The internal diameter of the tube is thus small enough to promote rapid transfer of heat from the tube walls to the center of the fluid stream flowing through the tube. Certain embodiments have a reaction tube having an internal diameter of about 1.0-10 mm, about 1.0 mm or less, about 0.1-1.0 mm, about 0.1-0.5mm, or about 0.25-0.8 mm, or about 0.5-2.0 mm, or about 1-5 mm In certain embodiments, the reactor tube is characterized by an outer diameter of about 1.0 mm or less, about 1.0-20 mm, about 1.0-10 mm, or about 1.0-5.0 mm

The reactor tube will have a wall thickness great enough to provide dimensional stability and sturdiness to the tube, but the wall may otherwise be as thin as possible while remaining sufficient for the desired operating pressures and temperatures. If the tube material has high heat conductivity, the tube will permit rapid heat transfer and the choice of wall thickness will have less importance with regards to heat transfer.

The reactor tube can be wrapped around the core in a helical pattern in some embodiments, to permit a reactor tube that is much longer than the core to fit comfortably inside the reactor. The helical winding of the reactor tube around the core may be characterized by a pitch. The pitch (average distance between windings on the core) is just a convenient way to discuss how the reactor tube is placed on (wrapped around) the core; it is a function of how long the reactor tube is relative to the length of the reactor core, and is not otherwise critical to the function of the reactor. Wrapping the tube around the core is a convenient and easily varied way of keeping it in close contact with the core to promote efficient heat transfer, while also permitting the length of the reactor tube to vary without having to change the entire reactor. In some embodiments, it may be preferable for the placement of the windings to be such that the reactor tube does not contact itself in successive circuits around the core, as this may improve heat transfer; in other embodiments, the windings may be in contact with each other in order to accommodate a larger number of windings around the core, i.e., a longer reaction pathway that is in the heated reactor. The average pitch of the reactor tube winding around the core is about 0.1 cm-1 cm per revolution around the core; 0.5 cm-10 cm; at least 1 cm; at least 2 cm; 1-8 cm; 1-5 cm; or 2-7 cm. The pitch may vary between windings. Pitch variance can be up to 3%, 5%, 10%, 20%, 50% or greater than 50%. In some embodiments the pitch does not vary by more than 5%, 10%, 15%, or 20%. The pitch of the reactor tube influences the residence time of a reaction mixture in the tube reaction channel as well as the potential length of the reactor tube that is within the reactor. For example, a decrease in pitch permits more windings per length of the core, which also permits an increase in tube channel length and residence time of a reaction mixture winding around the core. An increase in pitch reduces the number of windings per length of the core, which in turn reduces tube channel length and the residence time of a reaction mixture winding around the core. These two examples assume a constant core length and provide sufficient reactor tube length to wind around the entire length of the core.

In some embodiments, the reactor tube is simply wrapped around the core repeatedly without introducing other bends or distortions into the shape of the reactor tube. In other embodiments, the reactor tube may have additional bends introduced in specific zones to increase turbulent flow and promote mixing. Such additional bends may be used to promote turbulent flow where desired, such as in a nucleation zone that might be desirable in the section of the reactor tube just past the point where it enters the reactor and contacts the reactor core. Sections where additional bends are incorporated into the reactor tube can still be shaped so they conform to the reactor core and can be in effective thermal contact with the core or the sleeve or both.

Optionally, the sleeve is designed to clamp around the core when a reaction tube is wrapped tightly around the core. The clamping mechanism may be adapted to provide a small amount of pressure on the reaction tube, in order to ensure the reaction tube is in good thermal contact with both the core and the sleeve. FIG. 1 depicts a design that can be used to achieve this, using bolts or screws to attach together two halves of a sleeve that is split along its longitudinal axis. Referring to FIGS. 1A and 1B, a reactor design is shown in which one portion (124) of the reactor sleeve 200 includes holes 122, which optionally can be threaded, through which bolts or screws can pass for joining to a second portion (128) of the reactor sleeve. The screws or bolts can join the two reactor sleeve portions via insertion into threaded holes 130 in sleeve portion 128. Optionally, small beads, studs or even pieces of tubing having the same diameter as the reaction tube can be attached to the inner surface of the sleeve or, preferably, to the outer surface of the core. These provide a spacing mechanism so that clamping the pieces of the sleeve over the reactor tube-wrapped core will not inadvertently crush the reactor tubing if thin-walled tubing is used.

Residence time refers to the amount of time a reaction mixture spends in the reactor, which provides a heated reaction zone where a chemical transformation is intended to occur, and is determined by the cross-sectional area of the flow path, the length of the flow path, and the flow velocity of the reaction mixture. All of these can be adjusted by changing the reactor tube, by modifying either its length or its inner diameter. The residence time of a reaction mixture in the reactor can be modified by increasing or decreasing the length of the reactor tube in contact with the heated core or within the heated mass of the reactor. The residence time can also be adjusted by changing the inner diameter. In some embodiments, the residence time of the reaction mixture in the reactor is modified without requiring changing flow velocity. In some embodiments, the residence time is modified by simply disassembling the reactor, replacing the reactor tube with one of a desired different pitch and sufficient length, and reassembling the reactor. In other embodiments, the residence time is modified by disassembling the reactor, manually adjusting the pitch of the reactor tube as desired, and reassembling the reactor.

This design allows for different length of tubing to be used with the same reactor: merely by changing the number of times the reactor tube wraps around the core, the reactor tube length inside the reactor can be increased or decreased, limited at the lower end by the distance between inlet and outlet openings for the reactor tube to go into the reactor and come back out. Thus, a wide range of residence times can be achieved with a given size of reactor tubing, just by changing the length of the reactor tube in the reactor. Similarly, the residence time can be changed by modifying the internal diameter of the reaction tube, though there can be practical limitations with this approach. For example, since the pressure needed to maintain a desired flow rate may go up sharply if the inner diameter becomes too thin, the walls of the tubing may become too fragile if the inner diameter is too large.

Different diameters of reactor components can be fabricated to accommodate tubing with different outer diameters; but the reactor design permits a user to change only one piece of the reactor rather than replacing both the core and the sleeve. Thus a reactor tube having a larger external diameter can be accommodated by either making the core smaller in its outer diameter without changing the inner diameter of the sleeve, or by making the inner diameter of the sleeve larger, without necessarily changing the size of the core.

In most cases, unless otherwise specified, the “residence time” of a reaction mixture in the tube reaction channel refers to the time that is required for a reaction mixture to flow through the reactor. In some embodiments, the “residence time” of a reaction mixture in the reaction channel refers to the time that is required to flow through the portion of the reaction tube channel that is heated sufficiently to form nanocrystals; wherein in further specific embodiments, the portion of the reaction tube channel that is heated sufficiently to form nanocrystals is limited to the length of the tubing within the interior of the reactor sleeve. In some embodiments, the “residence time” of a reaction mixture in the reaction channel refers to the time that is required to flow from the point of entry into the sleeve of the reactor, such as the entry port, through the channel windings around the core, to the point of exit out of the sleeve of the reactor, such as the exit port. In alternative embodiments, the residence time is the time required for a reaction mixture to flow from the inlet in fluid communication with the reaction tube channel, through the windings around the core, to the outlet in fluid communication with the reaction tube channel.

In some embodiments, the inlet and outlet are located close to the reactor. In specific embodiments, the inlet is located close to or immediately outside the reactor sleeve or close to or immediately prior to the portion of the reactor tube that forms windings around the core; and the outlet is located close to or immediately outside the reactor sleeve or close to or immediately after the portion of the reactor tube that forms windings around the core. In other embodiments the inlet and/or outlet is not near the exterior of the reactor sleeve, depending on the length of the reactor tubing that extends outside the exterior surface of the reactor sleeve.

The sleeve, core and reactor tube are comprised of materials possessing at least thermal conductivity, such as stainless steel, aluminum, copper, alloys or combination thereof. The core and sleeve may both be of the same material, or they may comprise two or more different materials. These components are exposed to heat, but not to the reaction mixture, thus they are chosen to be able to withstand the desired operating temperatures, such as temperatures suitable for nanocrystal formation reactions. Aluminum is a suitable material for the core and sleeve, for example, and is relatively inexpensive to obtain and machine. Other materials such as cast iron, steel, copper, brass, tin, and alloys comprising any of these materials, and the like can also be used.

The reactor tube can be made of glass or fused silica, or it can be made of stainless steel or similar materials resistant to the reaction mixtures to be used. In some embodiments, the reactor tube channel further comprises a lining of a material different from the bulk reactor tube material. In specific embodiments, at least a portion of the tube channel is lined with a non-reactive, thermally resistant material such as an aforementioned metal, a synthetic polymeric material, and alloy or a combination thereof. The thermally resistant material must be stable at least at reaction temperatures suitable for the synthesis of the nanocrystals of interest, and unreactive with the reaction mixture. In some embodiments, the reactor tube comprises a material which has sufficient malleability such that the pitch, form or shape of the reactor tube can be manipulated by hand or machine, with or without heating, yet retain its integrity and without collapse of the reaction tube channel.

In some embodiments, spaces between any of the sleeve, core and/or reactor tube are at least partially filled in with a thermally conductive material, such as steel wool, and/or an insulating material, such as glass wool. In other embodiments, spaces between any of the sleeve, core and/or reactor tube are at least partially filled in with a thermally conductive material. In some embodiments, the thermally conductive material and insulating material is not a liquid.

The inner surface of the sleeve and the outer surface of the core are spaced apart by a gap distance along the length of the sleeve. In some embodiments, the gap distance approximates the diameter of the reactor tube. In some embodiments, the gap distance is less than the diameter of the reactor tube, for example, when the tube fits into grooves in the core and/or sleeve, or when ridges extend from the core and/or sleeve and surround at least a portion of the reactor tube. In some embodiments, the gap distance is greater than the reactor tube, for example, when the reactor tube is tightly wound around the core and the inner diameter of the sleeve is sufficient enough such that there is at least a portion of the reactor tube that has no contact along the length of the inner surface of the sleeve. In particular embodiments, at least a portion of the reactor tube has simultaneous thermal contact with the outer surface of the core surface and the inner surface of the sleeve. The gap distance is the distance between the outer core surface and the inner surface of the sleeve required to achieve this configuration.

In other aspects, a reactor for preparing an inorganic compound is provided, comprising any reactor described herein, wherein the inorganic compound comprises nanocrystal, typically a semiconductor nanocrystal. In some embodiments, any reactor described herein further comprises nanocrystal precursors or a reaction mixture. In specific embodiments, the reactor tube contains nanocrystal precursors or reaction mixture flowing through the reaction channel, or a nanocrystal in a liquid medium.

In particular embodiments, the nanocrystals described herein are from about 1 nm to about 100 nm in diameter, sometimes from about 1 to about 50 nm in diameter, and sometimes from about 1 to about 25 nm in diameter. For a nanocrystal that is not substantially spherical, e.g. rod-shaped, it may be from about 1 to about 100 nm, or from about 1 nm to about 50 nm, or from about 1 nm to about 25 nm in its smallest dimension.

Generally, a nanocrystal is a semiconductive particle, having a diameter or largest dimension in the range of about 1 nm to about 100 nm, or in the range of about 2 nm to about 50 nm, and in certain embodiments, in the range of about 2 nm to about 20 nm or from about 2 to about 10 nm. More specific ranges of sizes include about 0.5 nm to about 5 nm, about 1 nm to about 50 nm, and about 1 nm to about 20 nm. Specific size examples include about 0.1 nm, about 0.5 nm, about 1 nm, about 2 nm, about 3 nm, about 4 nm, about 5 nm, about 6 nm, about 7 nm, about 8 nm, about 9 nm, about 10 nm, about 11 nm, about 12 nm, about 13 nm, about 14 nm, about 15 nm, about 16 nm, about 17 nm, about 18 nm, about 19 nm, about 20 nm, about 25 nm, about 30 nm, about 35 nm, about 40 nm, about 45 nm, about 50 nm, and ranges between any two of these values. In some embodiments, a core nanocrystal less than about 10 nm in diameter, or less than about 7 nm in diameter, or less than about 5 nm in diameter is provided.

A typical single-color preparation of nanoparticles has crystals that are preferably of substantially identical size and shape. Nanocrystals are typically thought of as being spherical or nearly spherical in shape, but can actually be any shape. Certain nanocrystals can be non-spherical in shape. For example, the nanocrystal's shape can change towards oblate spheroids for redder colors. It is preferred that at least about 60%, at least about 70%, at least about 80%, at least about 90%, at least about 95%, and ideally about 100% of the particles are of the same size. Size deviation can be measured as root mean square (“rms”) of the diameter, with less than about 30% rms, preferably less than about 20% rms, more preferably less than about 10% rms. Size deviation can be less than about 10% rms, less than about 9% rms, less than about 8% rms, less than about 7% rms, less than about 6% rms, less than about 5% rms, or ranges between any two of these values. Such a collection of particles is sometimes referred to as being “monodisperse”. One of ordinary skill in the art will realize that particular sizes of nanocrystals, such as of semiconductor nanocrystals, are actually obtained as particle size distributions.

In certain embodiments, the nanoparticles can be a core/shell nanocrystal having a nanocrystal core covered by a semiconductor shell. The thickness of the shell can be adapted to provide desired particle properties. The thickness of the shell may affect fluorescence wavelength, quantum yield, fluorescence stability, and other photostability characteristics.

In some embodiments, nanoparticles prepared from the nanocrystals described herein are bright fluorescent particles, e.g., having a quantum yield of at least about 10%, sometimes at least 20%, sometimes at least 30%, sometimes at least 40%, sometimes at least 50%, and sometimes greater than about 70%. Nanocrystals generally require a surface layer of ligands to protect the nanocrystal from degradation in use or during storage.

In particular, exemplary materials that can be prepared using the present reactor include those semiconductor nanocrystals known to be of use in biological and chemical assays including, but not limited to, Group 2-16, 12-16, 13-15 and 14 element-based semiconductors such as ZnS, ZnSe, ZnTe, CdS, CdSe, CdTe, MgS, MgSe, MgTe, CaS, CaSe, CaTe, SrS, SrSe, SrTe, BaS, BaSe, BaTe, GaN, GaP, GaAs, GaSb, InP, InAs, InSb, AlS, AlP, AlSb, PbS, PbSe, Ge and Si and ternary and quaternary mixtures thereof. In a particular embodiment, the first element is In and the second element is P or As. In another embodiment, the first element is Cd and the second element is Se. Exemplary core materials that can be made in the present reactor include InP and CdSe.

In some embodiments, the metal atoms of a shell layer on a nanocrystal core are selected from In, Cd, Zn, Ga and Mg. The second element in these semiconductor shell layers can be selected from S, Se, Te, P, As, N and Sb. In certain embodiments, the shell is or comprises ZnS.

It is well known that the color (emitted light) of the semiconductor nanocrystal can be “tuned” by varying the size and composition of the nanocrystal. Nanocrystals preferably absorb a wide spectrum of wavelengths, and emit a narrow wavelength of light. The excitation and emission wavelengths are typically different, and non-overlapping. The nanoparticles of a monodisperse population may be characterized in that they produce a fluorescence emission having a relatively narrow wavelength band. Examples of emission widths (FWHM) include less than about 200 nm, less than about 175 nm, less than about 150 nm, less than about 125 nm, less than about 100 nm, less than about 75 nm, less than about 60 nm, less than about 50 nm, less than about 40 nm, less than about 30 nm, less than about 20 nm, and less than about 10 nm. The width of emission is preferably less than about 150 nm, less than about 100 nm, or less than about 50 nm at full width at half maximum of the emission band (FWHM). The emitted light preferably has a symmetrical emission of wavelengths. The emission maxima can generally be at any wavelength from about 200 nm to about 2,000 nm Examples of emission maxima include about 200 nm, about 400 nm, about 600 nm, about 800 nm, about 1,000 nm, about 1,200 nm, about 1,400 nm, about 1,600 nm, about 1,800 nm, about 2,000 nm, and ranges between any two of these values.

The nanoparticles can be treated to add various functionalities. For example, the nanoparticle can be treated with a surface coating. For example, the nanocrystals can be coated with lipids, phospholipids, fatty acids, polynucleic acids, polyethylene glycol, primary antibodies, secondary antibodies, antibody fragments, protein or nucleic acid based aptamers, biotin, streptavidin, proteins, peptides, small organic molecules, organic or inorganic dyes, precious or noble metal clusters. The coating can comprise an organic material, such as a layer of TOP or TOPO or other coordinating ligands that can make the nanocrystal or quantum dot soluble in hydrophobic media, or a hydrophilic coating such as an AMP coating as discussed in U.S. Pat. No. 7,108,915, which provides a water-soluble or water dispersible composition.

Spectral characteristics of nanoparticles can generally be monitored using any suitable light-measuring or light-accumulating instrumentation. Examples of such instrumentation are CCD (charge-coupled device) cameras, video devices, CIT imaging, digital cameras mounted on a fluorescent microscope, photomultipliers, fluorometers and luminometers, microscopes of various configurations, and even the human eye. The emission can be monitored continuously or at one or more discrete time points.

The nanocrystal core and shell can be made of any suitable metal and non-metal atoms that are known to form semiconductor nanocrystals. Semiconductor nanocrystals may be made in the present reactor system using techniques known in the art. See, e.g., U.S. Pat. Nos. 6,048,616, 5,990,479, 5,690,807, 5,505,928 and 5,262,357, as well as International Patent Publication No. WO 99/26299, published May 27, 1999. These methods typically produce nanocrystals having a coating of hydrophobic ligands on their surfaces which protect them from rapid degradation.

The nanoparticles are often fluorescent, due to the presence of a fluorescent nanocrystal core. The nanoparticles are often characterized by a fluorescence maximum in the visible spectrum, and frequently the fluorescence of a monodisperse population of nanocrystals is characterized in that when irradiated the population emits light for which the peak emission is in the spectral range of from about 470 nm to about 620 nm.

In some embodiments, a core semiconductor nanocrystal is modified to enhance the efficiency and stability of its fluorescence emissions, prior to ligand modifications described herein, by adding an overcoating layer or shell to the semiconductor nanocrystal core. Having a shell may be preferred, because surface defects at the surface of the semiconductor nanocrystal can result in traps for electrons, or holes that degrade the electrical and optical properties of the semiconductor nanocrystal core, or other non-radiative energy loss mechanisms that either dissipate the energy of an absorbed photon or at least affect the wavelength of the fluorescence emission slightly, resulting in broadening of the emission band. An insulating layer at the surface of the semiconductor nanocrystal core can provide an atomically abrupt jump in the chemical potential at the interface that eliminates energy states that can serve as traps for the electrons and holes. This results in higher efficiency in the luminescent processes.

Suitable materials for the shell include semiconductor materials having a higher bandgap energy than the semiconductor nanocrystal core. In addition to having a bandgap energy greater than the semiconductor nanocrystal core, suitable materials for the shell should have good conduction and valence band offset with respect to the core semiconductor nanocrystal. Thus, the conduction band is desirably higher and the valence band is desirably lower than those of the core semiconductor nanocrystal. For semiconductor nanocrystal cores that emit energy in the visible (e.g., CdS, CdSe, CdTe, ZnSe, ZnTe, GaP, GaAs) or near IR (e.g., InP, InAs, InSb, PbS, PbSe), a material that has a bandgap energy in the ultraviolet regions may be used. Exemplary materials include ZnS, ZnTe, GaN, and magnesium chalcogenides, e.g., MgS, MgSe, and MgTe. For a semiconductor nanocrystal core that emits in the near IR, materials having a bandgap energy in the visible, such as CdS or CdSe, may also be used. The preparation of a coated semiconductor nanocrystal may be found in, e.g., Dabbousi et al. (1997) J. Phys. Chem. B 101:9463, Hines et al. (1996) J. Phys. Chem. 100: 468-471, Peng et al. (1997) J. Am. Chem. Soc. 119:7019-7029, and Kuno et al. (1997) J. Phys. Chem. 106:9869. It is also understood in the art that the actual fluorescence wavelength for a particular nanocrystal core depends upon the size of the core as well as its composition, so the categorizations above are approximations, and nanocrystal cores described as emitting in the visible or the near IR can actually emit at longer or shorter wavelengths depending upon the size of the core.

Where a core/shell fluorescent semiconductor nanocrystal is used, it is sometimes advantageous to make the nanoparticle as small as practical; thus in some embodiments, the nanocrystal is less than about 10 nm in diameter, and often less than about 8 nm, and sometimes less than about 6 nm in diameter, and in some embodiments, the nanocrystal is less than about 5 nm in diameter or size, or less than 4 nm in diameter or size.

In some embodiments, the nanocrystals made with the novel reactor comprise a nanocrystal core that is less than about 10 nm in diameter, or less than about 7 nm in diameter, or less than about 5 nm in diameter. The small size of these nanocrystals is advantageous in many applications.

In some embodiments, the apparatus is suitable for making a coated core/shell nanocrystal that is less than about 20 nm in diameter. The coating can comprise an organic material, such as a layer of TOP or TOPO or other coordinating ligands that can make the nanocrystal or quantum dot soluble in hydrophobic media, or a hydrophilic coating such as an AMP coating as discussed in U.S. Pat. No. 7,108,915, which provides a water-soluble or water dispersable composition.

Nanocrystal precursors are represented by a M-source and an X-donor. The M-source can be an M-containing salt, such as a halide, carboxylate, carbonate, hydroxide, or diketonate, in which M can be Cd, Zn, Mg, Hg, Al, Ga, In, or Tl. X can be O, S, Se, Te, N, P, As, or Sb. The mixture can include an amine, such as a primary amine (e.g., a C8-C20 alkyl amine). The X donor can include a phosphine chalcogenide, a bis(silyl) chalcogenide, dioxygen, an ammonium salt, or a tris(silyl) pnictide.

The M-source and the X donor can be combined by contacting a metal, M, or an M-containing salt, and a reducing agent to form an M-containing precursor. The reducing agent can be selected from the group consisting of tertiary phosphines, secondary phosphines, primary phosphines, amines, hydrazines, hydroxyphenyl compounds, hydrogen (optionally with a catalyst), hydrides (including, e.g., metal hydrides such as lithium aluminum hydride and borohydrides), metals, boranes, aldehydes, alcohols, thiols, reducing halides, polyfunctional reductants, and mixtures thereof.

Suitable M-containing salts include cadmium acetylacetonate, cadmium iodide, cadmium bromide, cadmium chloride, cadmium hydroxide, cadmium carbonate, cadmium acetate, cadmium oxide, zinc acetylacetonate, zinc iodide, zinc bromide, zinc chloride, zinc hydroxide, zinc carbonate, zinc acetate, zinc oxide, magnesium acetylacetonate, magnesium iodide, magnesium bromide, magnesium chloride, magnesium hydroxide, magnesium carbonate, magnesium acetate, magnesium oxide, mercury acetylacetonate, mercury iodide, mercury bromide, mercury chloride, mercury hydroxide, mercury carbonate, mercury acetate, aluminum acetylacetonate, aluminum iodide, aluminum bromide, aluminum chloride, aluminum hydroxide, aluminum carbonate, aluminum acetate, gallium acetylacetonate, gallium iodide, gallium bromide, gallium chloride, gallium hydroxide, gallium carbonate, gallium acetate, indium acetylacetonate, indium iodide, indium bromide, indium chloride, indium hydroxide, indium carbonate, indium acetate, thallium acetylacetonate, thallium iodide, thallium bromide, thallium chloride, thallium hydroxide, thallium carbonate, or thallium acetate. Suitable M-containing salts also include, for example, carboxylate salts, such as oleate, stearate, myristate, and palmitate salts, mixed halo carboxylate salts, such as M(halo)(stearate) salts, as well as phosphonate salts.

Alkyl groups can be branched or unbranched saturated hydrocarbon group of 1 to 100 carbon atoms, preferably 1 to 30 carbon atoms, such as methyl, ethyl, n-propyl, isopropyl, n-butyl, isobutyl, t-butyl, octyl, decyl, tetradecyl, hexadecyl, eicosyl, tetracosyl and the like, as well as cycloalkyl groups such as cyclopentyl, cyclohexyl and the like. Optionally, an alkyl can contain 1 to 6 linkages selected from the group consisting of —O—, —S—, —M— and —NR— where R is hydrogen, or C1-C8 alkyl or lower alkenyl.

Prior to combining the M-containing salt with the X donor, the M-containing salt can be contacted with a coordinating solvent to form an M-containing precursor. Typical coordinating solvents include alkyl phosphines, alkyl phosphine oxides, alkyl phosphonic acids, or alkyl phosphinic acids; however, other coordinating solvents, such as pyridines, furans, and amines may also be suitable for the nanocrystal production. Examples of suitable coordinating solvents include pyridine, tri-n-octyl phosphine (TOP) and tri-n-octyl phosphine oxide (TOPO). Technical grade TOPO can be used. The coordinating solvent can include a 1,2-diol or an aldehyde. The 1,2-diol or aldehyde can facilitate reaction between the M-containing salt and the X donor and improve the growth process and the quality of the nanocrystal obtained in the process. The 1,2-diol or aldehyde can be a C6-C20 1,2-diol or a C6-C20 aldehyde.

The X donor is a compound capable of reacting with the M-containing salt to form a material with the general formula MX. The X donor is generally a chalcogenide donor or a pnictide donor, such as a phosphine chalcogenide, a bis(trialkylsilyl)chalcogenide, dioxygen, an ammonium salt, or a tris(trialkylsilyl)pnictide. Suitable X donors include dioxygen, elemental sulfur, bis(trimethylsilyl)selenide ((TMS)₂Se), trialkyl phosphine selenides such as (tri-n-octylphosphine)selenide (TOPSe) or (tri-n-butylphosphine)selenide (TBPSe), trialkyl phosphine tellurides such as (tri-n-octylphosphine)telluride (TOPTe) or hexapropylphosphorustriamide telluride (HPPTTe), bis(trimethylsilyl)telluride ((TMS)₂Te), sulfur, bis(trimethylsilyl)sulfide ((TMS)₂S), a trialkyl phosphine sulfide such as (tri-n-octylphosphine) sulfide (TOPS), tris(dimethylamino) arsine, an ammonium salt such as an ammonium halide (e.g., NH₄Cl), tris(trimethylsilyl) phosphide ((TMS)₃P), tris(trimethylsilyl) arsenide ((TMS)₃As), or tris(trimethylsilyl) antimonide ((TMS)₃Sb). In certain embodiments, the M donor and the X donor can be moieties within the same molecule.

“Coordinating solvents” as used herein refers to a solvent such as TOP, TOPO, carboxylic acids, and amines, which are effective to coordinate to the surface of a nanocrystal. ‘Coordinating solvents’ include phosphines, phosphine oxides, phosphonic acids, phosphinic acids, amines, and carboxylic acids, which are often used in growth media for nanocrystals, and which form a coating or layer on the nanocrystal surface. They exclude hydrocarbon solvents such as hexanes, toluene, hexadecane, octadecene, and the like, which do not have heteroatoms that provide bonding pairs of electrons to coordinate with the nanocrystal surface. Hydrocarbon solvents that do not contain heteroatoms such as O, S, N or P to coordinate to a nanocrystal surface are referred to herein as non-coordinating solvents. Note that the term ‘solvent’ is used in its ordinary way in these terms: it refers to a medium that supports, dissolves, or disperses materials and reactions between them, but which does not ordinarily participate in or become modified by the reactions of the reactant materials. However, in certain instances, the solvent is modified by the reaction conditions. For example, TOP may be oxidized to TOPO, or a carboxylic acid may be reduced to an alcohol.

A reaction mixture comprises at least one of a nanocrystal precursor, a solvent, nanocrystal product or a combination thereof.

Mixing can be substantially completed prior to heating of the reaction mixture in the reaction zone. The presence of the mixing chamber can be important because once the M (e.g., Cd) and X (e.g., Se) precursor solutions are combined at room temperature, small MX (e.g., CdSe) clusters can form over several hours. The small clusters can result in irreproducibility in the sizes of the final nanocrystals produced by the reactor so the Cd and Se precursors preferably are not mixed until just prior to reaching the heated section. The volume of the mixer can be selected such that the chamber residence time was long enough to ensure complete mixing but short enough to avoid formation of small clusters.

In some embodiments, a heating device, such as a resistive heater which converts electricity into heat through the process of Joule heating, is in thermal contact with the reactor core and/or sleeve. In yet other embodiments, a heating element is embedded in the core and or sleeve. In specific embodiments, the means for heating the reactor tube is an optionally removable cartridge heater inserted into the core and/or sleeve of the reactor and heats the core and/or sleeve. A cartridge heater is a device, usually tubular, that is inserted into a drilled hole of a metal block, and upon activation, transfers heat to the surrounding material. In alternative embodiments, means for heating the reactor tube is a device, such as an oven or furnace, wherein the reactor is placed and which heats the entire reactor including the reactor tube. Most importantly, the core and/or sleeve are heated to the desired temperature, for example, the temperature at which the nanocrystal is permitted to form, and at least a portion of the core or a portion of the core and sleeve is in thermal contact with the reactor tube. As a result, the reactor tube is heated to the desired temperature. The core and sleeve provide a source of uniform and constant heating for the reactor tubing, such that the reaction mixture flowing through the reactor tubing is quickly and evenly heated to a temperature that is closely maintained throughout the flow path in the reactor tube portion that is in contact with the heating source. In some embodiments, liquids used for thermal conduction inside the reactor and outside the reactor tubing, such as silicon oil or any high boiling liquid, is excluded. In these embodiments, thermal conduction by liquid means is avoided for reasons not limited to safety, reactor performance, and ease of repeated assembly/disassembly of the reactor.

In certain embodiments, the reactor tube is designed to promote turbulent flow within the reaction mixture flow path. Turbulent flow is characterized by a chaotic stochastic property changes. Turbulent flow aids in mixing of the reaction composition, which in turn impacts the quality of the nanocrystal, like polydispersity. The amount or degree of turbulent flow desired in the reactor tube can be optimized to provide the desired uniform, monodisperse, high-quality, most desirable nanocrystal. Turbulent flow can be modified by the flow velocity, but also by characteristics of the reactor tube, such as flow path, dimensions, shape, and pitch of the reactor tube. These parameters can be experimentally determined by making modifications to the reactor tube and comparing the product characteristics. Modifying these parameters is greatly facilitated by the modular design of the reactors provided herein.

In other aspects, a system for a continuous flow process for the production of an inorganic compound is provided, comprising
i. at least one reactor described herein;
ii. at least one reservoir for supplying a reaction mixture to the reaction channel; and
iii. a means for collecting the reaction mixture at the outlet.

In some embodiments, the reactor is part of a system that further comprises a means for heating the reaction mixture. Means for heating is typically adapted to heat only or primarily the reactor, which in turn heats the reaction mixture inside the reaction tube, where it is in the reactor. The heating means can be provided by a resistive electrical heating device that can be in contact with the core or the sleeve of the reactor, or both. Alternative heating means such as an oven or a radiative heater or a convection heater can also be used to heat the reactor.

In some embodiments, the system further comprises a mixer, wherein the nanocrystal precursors are combined together immediately prior to flowing into the reactor. In some embodiments, the system further comprises at least one sensor that monitors a particular property of the reaction mixture as described elsewhere in this application. In some embodiments, the sensor monitors the reaction mixture that flows out of the reactor. In some embodiments, the system comprises a means for collecting the reaction mixture, wherein the means can comprise simply a collection vessel, such as a flask, test tube, vial, ampoule, sealable container or open container. In other embodiments, the means for collection comprises a diverter, such as a valve, capable of diverting the flow to separate vessels, such as desired product and waste vessels, wherein the diverter comprises a section of the flow path after the reactor. Upon monitoring of the flow composition, the flow may be manually or automatically diverted to waste or product vessel accordingly. The means for collection can include a plurality of receptacles for collecting the reaction mixture, and a sample collector that sequentially directs the output from the reactor into a series of ordered receptacles, such as an array of collection tubes or bottles.

In some embodiments, the system further comprises means for monitoring at least one property of a nanocrystal produced in the flow reactor. These means can include any suitable light-measuring or light-accumulating instrumentation, such as spectrophotometric devices for monitoring the size, fluorescence wavelength, absorption, and other chemical and/or photophysical properties of the nanocrystals, to ensure consistent performance, or to adjust reaction conditions and reactor parameters so that desired properties are achieved.

In some embodiments, at least the reactor of a system described herein is surrounded by an inert atmosphere. In some embodiments, at least the reactor of the system is located in a dry box. This facilitates changing the reactor tube, for example, and permits samples of air-sensitive nanocrystals to be collected without further special precautions.

Quenching the reaction, and thus ceasing the growth of the inorganic shell surrounding the nanocrystal core, is done, in one embodiment, by cooling the reaction mixture using various methods. The cooling can be accomplished by, among other methods, contacting a heat transfer medium with the reaction tube, by adding solvent to the product mixture of a sufficiently low temperature to quench the reaction, or by cooling the product mixture once it emerges from the reaction tube. Active cooling of the reaction mixture or the reaction tube can be provided by, e.g., a bath that is capable of reducing the temperature of the reaction medium, or it can be achieved by exposing the reaction tube to unheated atmosphere and allowing it to cool by convection, or by directing the reaction mixture into a cooled or at least unheated collection receptacle. Alternative methods of quenching include diluting the reaction mixture to a degree that substantially reduces the rate of nanocrystal growth, or adding an agent that stops further reaction or rapidly consumes one of the essential components of the reaction.

In other aspects, a method of producing nanocrystals in a continuous flow process is provided, comprising introducing at least two semiconductor nanocrystal precursors into a reactor described herein, at a temperature sufficient to induce formation of a semiconductor nanocrystal, typically in a solvent suitable for supporting nanocrystal formation. The methods include causing the reaction mixture to flow through a reactor tube in a reactor as describe herein. The methods can be used to produce a core nanocrystal from precursors, wherein the reaction mixture and temperature, etc. are suitable to support nucleation to form nanocrystals from soluble precursors. In other embodiments, the reaction mixture can comprise nanocrystals provided as a nanocrystal core, which are then mixed with semiconductor nanocrystal precursors and are heated in a reactor provided herein under conditions that promote formation of a semiconductor shell on the nanocrystal core. Thus the described reactors can be used to form a core nanocrystal, or to apply a shell to a nanocrystal core, providing a core/shell nanocrystal. The nanocrystal core and shell can be made of the same or different materials, but typically the shell is comprised of a semiconductor material having a wider bandgap than that of the nanocrystal core, as is known in the art.

Either saturated and/or unsaturated solvents or precursors can be used in the methods described herein. In some embodiments, an unsaturated solvent can be used. In other embodiments, a saturated solvent is used, such as a saturated hydrocarbon, saturated alkylamine, saturated alkylphosphines, saturated carboxylic acid, saturated phosphonic acids, saturated phosphinic acids, saturated thiols, saturated esters, saturated ethers, saturated alcohols or saturated fluorinated solvent, or a mixture of such saturated components. Certain of these saturated solvents comprise at least 10 carbon atoms, In certain embodiments, the solvent is squalane, decylamine or a combination thereof.

In certain embodiments, the precursor comprises a saturated salt such as a stearate salt of a cationic semiconductor nanocrystal precursor. In some embodiments, the nanocrystal comprises InP and/or InAs. In specific embodiments, the method described herein eliminates the use of unsaturated materials containing carbon-carbon double bonds in the solvent and in the precursors. In some embodiments, the reaction mixture only comprises saturated components. Without wishing to be bound by theory, it is thought that minimizing the presence of unsaturated components can avoid unwanted polymerization of carbon-carbon double bonds. In certain embodiments, for example, the reaction uses at least one saturated precursor in at least one saturated solvent. In further specific embodiments, the method of producing nanocrystals comprises the use of elemental sulfur dispersed in decylamine as a sulfur precursor; zinc stearate in squalane as a zinc precursor or precursors dispersed in squalane solvent.

The methods provided herein can be used to produce a monodisperse population of nanocrystals, which can be nanocrystal cores or core/shell nanocrystals. Alternatively, by varying parameters such as temperature, residence time, reactor tube length, reactor tube diameter, and the like, the methods can be used to produce two or more different monodisperse populations of nanocrystals having different compositions, or at least different fluorescence characteristics, such as different fluorescence wavelength maxima.

In another aspect, a method is provided to optimize conditions for producing nanocrystals with a flow reactor. The method comprises:
i) producing a nanocrystal by introducing a reaction mixture comprising one or more semiconductor nanocrystal precursors into the reactor channel as described herein, and causing the reaction mixture to flow through the reactor tube, while the reactor tube is heated to a temperature sufficient to induce formation of a semiconductor nanocrystal.
ii) assessing the nanocrystal to determine whether it has a desired property;
iii) modifying at least one reaction parameter selected from residence time, ratio of nanocrystal precursors, concentration of nanocrystal precursors, and reactor temperature;
iv) producing a nanocrystal with the new reaction parameters; and
v) repeating the assessment and modification steps if necessary until a nanocrystal having the desired property is produced.

In another aspect, a method is provided for producing a nanocrystal shell comprising ZnS, comprising reacting a sulfur precursor dispersed in decyl amine with zinc stearate in squalane at a temperature sufficient to induce formation of a nanocrystal or to induce formation of a shell layer on the surface of a nanocrystal core. In one embodiment, the method further comprises the use of a reactor described herein, and/or the use of any method of producing nanocrystals in a continuous flow process described herein.

Spectral characteristics of nanoparticles can generally be monitored using any suitable light-measuring or light-accumulating instrumentation. Examples of such instrumentation are CCD (charge-coupled device) cameras, video devices, CIT imaging, digital cameras mounted on a fluorescent microscope, photomultipliers, fluorometers and luminometers, microscopes of various configurations, and even the human eye. The emission can be monitored continuously or at one or more discrete time points.

Additional methods of assaying the emission from the nanostructure include measuring changes in light intensity, light polarization, light absorption, color of the emission, emission lifetime or half-life.

Characteristic properties of the product stream, such as optical properties, electrical properties, magnetic properties, electromagnetic properties, and the like are detected. A comparison can made between the detected values and a predetermined or preselected target range that is indicative of the product quality sought to be achieved. Any discrepancy or deviation between the detected values and target range can then be used to adjust the variable reaction conditions, such as the temperature of the heat transfer medium, the flow rate of the reaction mixture through the tube, the length of the reaction tube, or any combination thereof, until the product changes sufficiently that the detected values fall within or otherwise conform to the target range.

The degree or extent of reaction also depends on the concentrations of the reactants, the length of the reaction tube, and the temperature and pressure of the reaction mixture inside the tube. As noted above, the temperature may be imposed by a heat transfer from the reactors described herein surrounding at least a portion of the reactor tube itself and/or by preheating the reactants prior to their entry into the tube. None of these operating parameters are limited to specific values, and each may vary considerably in accordance with the type of product being prepared and the characteristics and qualities that are sought in the product. The appropriate selection of these parameters is a matter of routine skill to those experienced or familiar with batchwise processes for these reactions. The choice of the tube dimensions, for example, will depend on the desired flow rate and temperature as well as other parameters of the system. In most applications, it is contemplated that the reaction tube will be from about 3 cm to about 300 cm in length, or about 10 cm to about 100 cm in length. Likewise, the most typical temperatures will be at least about 100° C., and preferably within the range of from about 100° C. to about 400 ° C., more preferably within the range of about 250° C. to about 400 ° C. These temperature ranges are applicable to both the nanocrystal core-forming reaction and the shell-forming reaction. The flow system may be used for forming a nanocrystal core, or, as illustrated by embodiments described herein, for applying a semiconductor shell to a pre-made nanocrystal core. Suitable materials and conditions for these reactions are known in the art, and can generally be adapted for use in the flow systems provided herein by routine experimentation.

Monitoring of the product stream is performed by conventional apparatus for the on-line detection of the determinative or characteristic properties of the product stream. Examples of these properties are absorbance of electromagnetic radiation, emission of electromagnetic radiation, both absorbance and emission of electromagnetic radiation, static or dynamic light scattering, refractive index, conductance, and magnetic susceptibility. Static light scattering, dynamic light scattering, or refractive index, for example, can be used to assess the size distribution of the particles. Conductance can be used with charged particles to obtain a particle count, and magnetic susceptibility can be used with magnetic or paramagnetic particles to determine the size distribution, particle count, or both. All of these properties can be detected by techniques that are known in the art using instrumentation that is commercially available. In some embodiments, the properties detected are optical properties such as, for example, emission intensity, emission wavelength, full width at half maximum peak height (FWHM), absorption, light scattering, fluorescence lifetime, or combinations of these properties.

Detection can be performed at a site downstream of the reactor. Alternatively, detection can be performed on-line within the reactor and reaction tube itself, in which case a tube that permits such detection is used. In another alternative embodiment, a sample stream from a point in the reactor is by-passed into a detection unit to determine the composition and product state within the reactor. In certain embodiments, the product mixture is cooled at or near the site where detection is performed. Thus, when on-line detection is performed, the product mixture is preferably cooled as it emerges from the reactor but before it reaches the on-line detection point. In some embodiments, the system further comprises at least one sensor, wherein the sensor is used to monitor a property of the reaction mixture.

Cooling in these embodiments is done to lower the temperature of the product stream enough to substantially quench any reaction still occurring in the moving stream and to standardize the detection temperature, thereby eliminating variations in the optical properties due to temperature. Cooling can be accomplished by passing the product stream through a cooling tube, or a downstream section of the reaction tube, embedded or immersed in a cooling medium in a manner analogous to the heat transfer medium used to heat the starting materials to reaction temperature. It is often sufficient to cool the material passively by simply removing the heating element at the end of the reaction zone. Alternatively, cooling can be achieved by diluting the product stream with additional solvent at an appropriately low temperature. In certain embodiments, the injection of additional solvent provides an additional benefit (for example, when the solvent in which the reaction takes place is a mixture of species such as tri-n-octylphosphine and tri-n-octylphosphine oxide, one of which has a melting point above room temperature, the addition of a further amount of a lower-melting solvent species for cooling purposes can prevent freezing of the higher-melting species and facilitate handling of the product stream).

The properties that are monitored may be any detectable properties that serve as an indication of the size, size distribution, or yield of the nanocrystals, the thickness of the coating, the surface characteristics, or in general the degree or quality of reaction that has occurred in the reaction tube. Absorbance is readily measured by irradiating the product stream with light and determining the absorption spectra. Light scattering is readily measured by illuminating the product stream and detecting the direction or amount of scattered light, either one being characteristic of the properties of the nanocrystals and their chemical composition. Photoluminescence is readily measured by irradiating the product stream with light of an appropriate wavelength to excite the nanoparticles and detecting the emission spectra resulting from the excitation. Conventional spectrophotometers or other light detecting devices can be used.

Comparison of the spectra with a target range is then performed to determine whether adjustments are needed to the reaction conditions in order to shift the spectra into the target range. If the shift can be achieved by a change in the reaction temperature, the comparison can serve as a means of determining how much and in which direction to modify the temperature of the heat transfer medium and hence the temperature in the reaction tube. If the shift can be achieved by a change in the residence time in the reactor, the reaction comparison can be performed visually in a trial run or at the start of the process or at any time during the progress of the reaction, and adjustments to the temperature can be made manually by the operator. Alternatively, the comparison can be performed by automated instrumentation, and if desired, on a continuous basis, with a corresponding adjustment in temperature or flow rate until the comparison produces a favorable result.

The following examples are offered to illustrate but not to limit the invention.

### EXAMPLE 1

### Process Flow Diagram

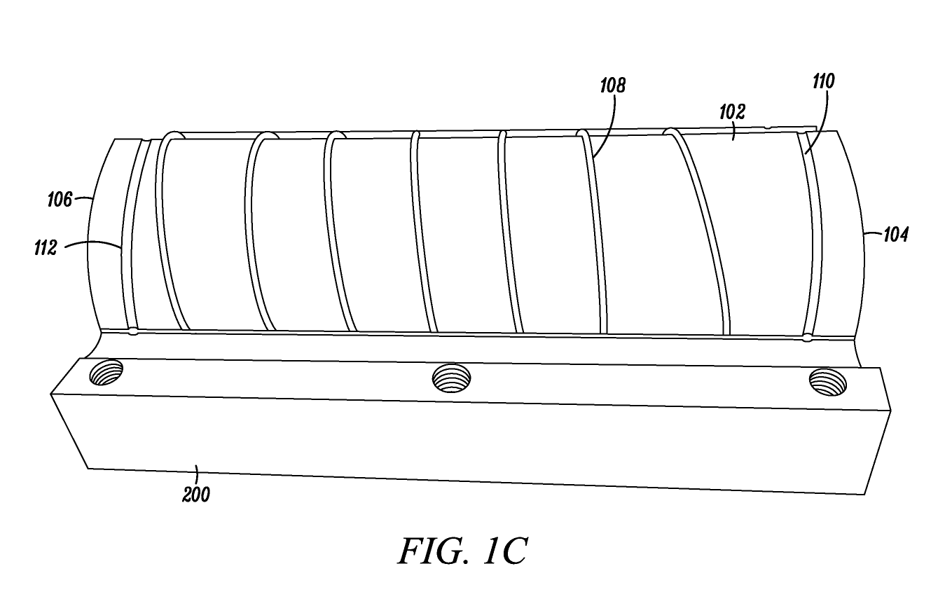

FIG. 3 is a process flow diagram illustrating one example of a rudimentary system embodying the reactors provided herein. Nanocrystal precursor solutions are prepared and transferred to a syringe. The syringes are loaded onto computer-controlled metering pumps 2 (syringe or gear pump). The mixture of precursors is delivered to a mixer 3 and is then transferred to the reactor 4. In some embodiments, the system comprises two or more reactors connected in serial and/or parallel. Heating is provided to the reactor as needed, either by heating devices in or on the core and/or sleeve of the reactor, or by placing the reactor into a heated zone such as an oven. At the outlet of the reactor 4, the product stream passes through a flow-through monitoring cell 5 which includes an ultraviolet light source to excite the nanocrystals in the product stream and a CCD-based miniature spectrometer to measure the absorbance spectra from the nanocrystals. At the outlet of the monitor, the product stream passed through a diverter 6 that can be manually switched between product and waste. If the final product stream is acceptable, the finished nanocrystals are collected in a product recovery unit 7. If the final product stream is unacceptable, the finished nanocrystals are diverted to waste 8. Parameters relating to the pumps 2, reactor 4, and monitor 5 can by adjusted via a controller 1, attached to any one or more of these components.

Using this system, one can conveniently adjust parameters including reaction temperature, flow velocity (by adjusting pump volume or pressure), ratio of precursors, concentrations (by using the third pump to introduce additional solvent, for example), or other paramters to determine how each of the parameters affects the nanocrystals product obtained.

### EXAMPLE 2

### Synthesis Of InP Nanocrystals

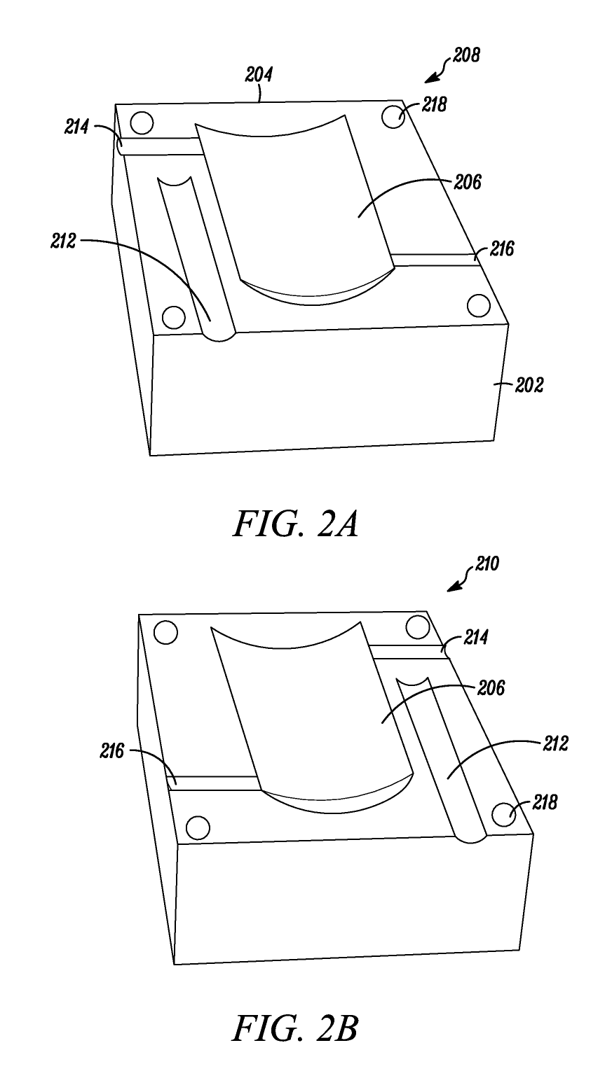

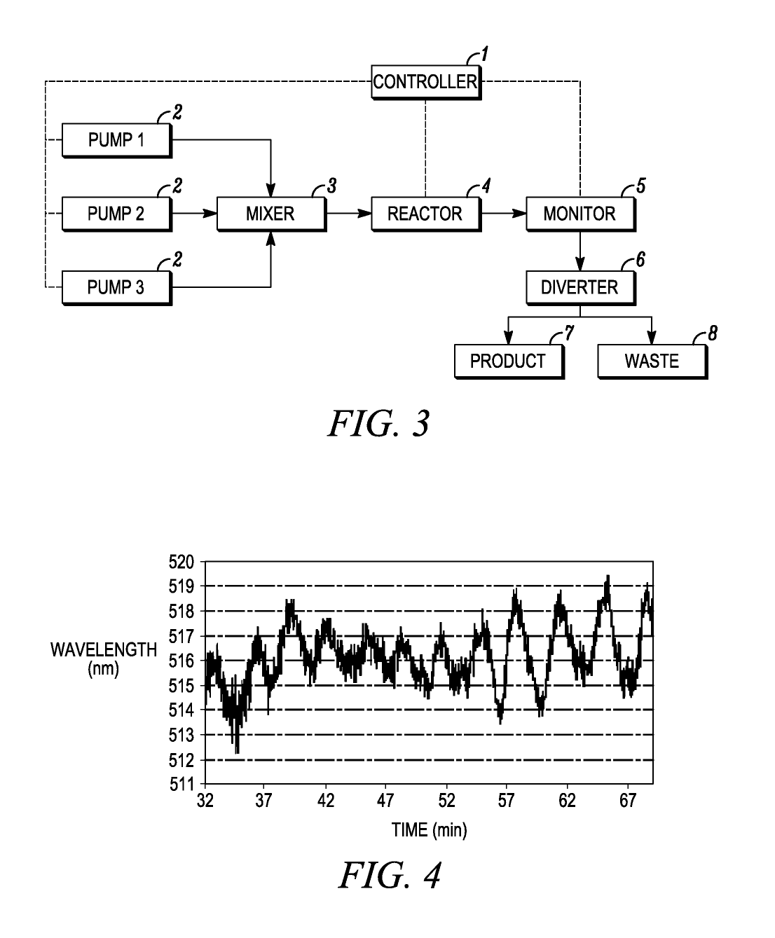

InP core nanocrystals were prepared by continuous flow synthesis as follows. First an indium precursor was prepared by adding 0.88 g indium (III) acetate, 0.254 g oleic acid and 14.8 g 1-octadecene that has been purified to remove oxygen and water (ODE) to a reaction flask under inert atmosphere. The contents of the flask were heated to 260° C. while applying a flow of nitrogen to remove acetic acid that may have formed. After 5 minutes at 260° C., the flow of nitrogen was stopped. The solution was allowed to cool before drawing the entire contents of the flask into a gastight glass syringe. Next a phosphorus precursor was prepared by adding 0.45 g (TMS)3P to 7.101 g ODE under inert atmosphere. The resulting phosphorus precursor solution was drawn up into a second gastight glass syringe. Finally, 20 mL of ODE was loaded into a third gastight syringe. The three syringes were connected to the flow system at pumps 1-3 as depicted in FIG. 3 and the reaction carried out using a residence time of 9 minutes and a 3:1 In:P ratio. The reactor, such as shown in FIG. 1, was used at 270° C., a temperature sufficient to induce nanocrystal growth, and the product was collected. FIG. 4 demonstrates that InP nanocrystals prepared using the continuous flow reactor exhibit minimal variation in absorbance wavelengths over time. FIG. 5 shows the absorbance properties of the collection of InP nanocrystals prepared over the course of approximately 1 hour using the continuous flow reactor system. The plot also demonstrates that the absorbance properties for the InP nanocrystal population remain stable during the course of the reaction. Also plotted in FIG. 5 is the absorbance of InP nanocrystals prepared in a batch mode using reaction parameters comparable to those used in the flow mode reaction (e.g., using a temperature of about 270° C. and a reaction time of 30 minutes). In batch mode, however, the solvent and indium precursor were heated to the reaction temperature then the phosphorus precursor is swiftly added. The data in FIG. 5 shows how similar the two populations of InP nanocrystals are in terms of the wavelength and half width half max (HWHM) of the absorbance peak despite being prepared by two different methods.

### EXAMPLE 3

### Investigation of Reaction Parameters in InP Core Synthesis

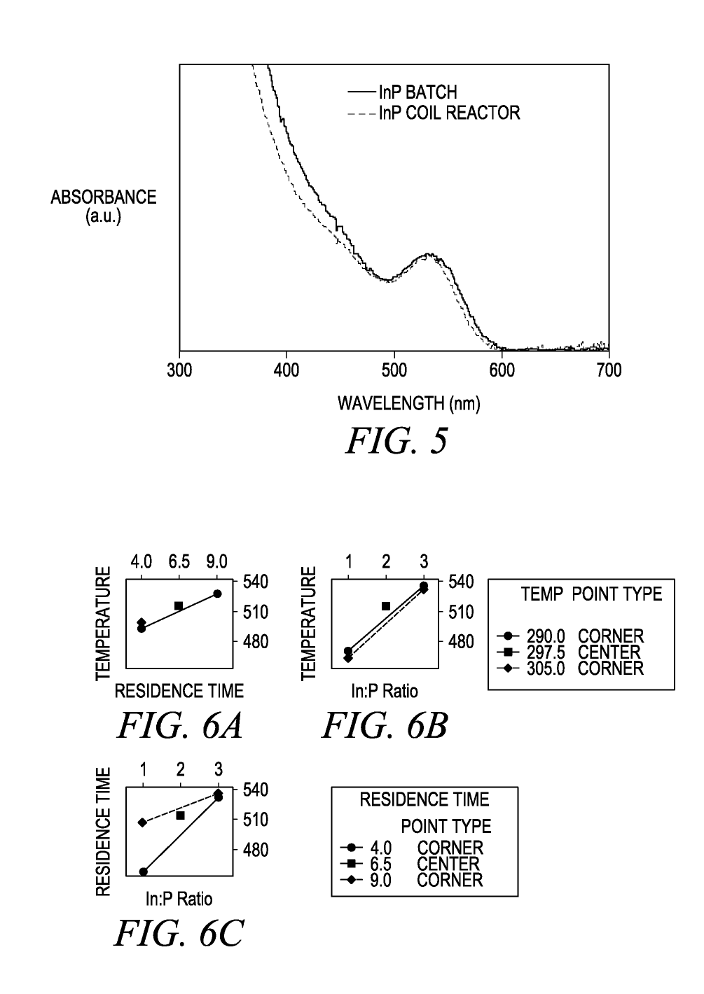

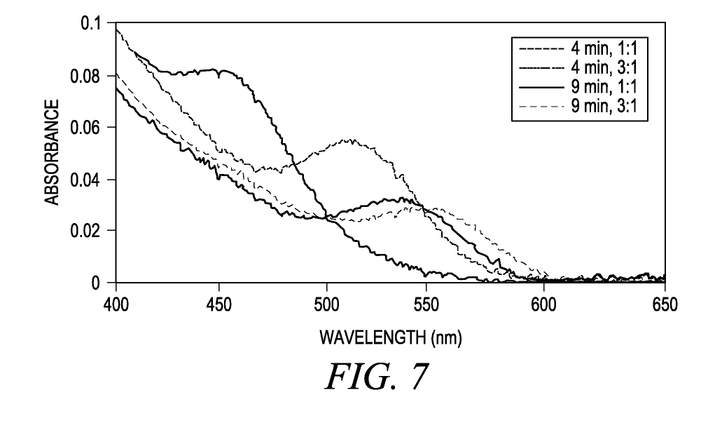

This example describes the use of a reactor as described herein in investigating effects of various reaction parameters, including temperature, residence time, and In:P ratios on nanocrystal synthesis. A continuous flow reaction was performed using the apparatus depicted in FIG. 1. Using a novel flow through reactor in a flow through system, the equivalent of 16 batch experiments were carried out in less than 5 hours. If one operator can run four reactions per day, then it would have taken four days in stirred-pot mode, demonstrating an advantage of the present system for the optimization of nanocrystal reaction parameters. In this time, the effect of residence time, In:P ratio and temperature on the synthesis of the nanocrystal product was investigated. Plotting absorbance data of the products generated in the various reaction conditions, the interaction plots indicate that increased residence times, increased In:P ratios or an increase in temperature results in red shift of the absorbance maximum (see, FIGS. 6 and 7). The plots also show that the effect of In:P ratio has a greater effect on absorbance wavelength at shorter residence times.

### EXAMPLE 4

### Use of Saturated Precursors in Preparation of InP/ZnS Core/Shells

The following representative example demonstrates the use of saturated solvents and precursors in a continuous flow synthesis.

Conventional protocols for applying a ZnS shell to an InP nanocrystal core were evaluated in a reactor such as described herein. The conventional methods included several unsaturated materials, including solvents (ODE) and other reagents (oleylamine, zinc oleate). It was found that using convention methods, these materials became clogged in the reactor. While not bound by theory, it is thought reactor clogging may be in part due to the polymerization of unsaturated components at elevated temperatures.

Flow shell synthesis reactions are provided that attempt to eliminate all unsaturated double bonds in the precursors and solvents. The solvent was changed to squalane, which is a fully saturated branched hydrocarbon with a high boiling point and a low freezing point. This solvent works equivalently to 1-octadecene (ODE) in batch mode. The sulfur precursor used previously was elemental sulfur dispersed in oleylamine (contains one double bond). Oleylamine was replaced with elemental sulfur dispersed in decylamine. This worked surprisingly well and made a red solution which was a liquid at room temperature. The zinc precursor was previously zinc oleate in ODE. This was replaced by zinc stearate in squalane. To use this precursor, it required pre-heating to above 100° C. to keep the solvent and precursor melt mixed.

The flow shell reaction was setup as illustrated in FIG. 3. InP cores in squalane, and sulfur and zinc precursors in saturated compositions as described above were loaded into three syringes and mounted on three separately controlled syringe pumps. First, just the core syringe was run through the reactor at 300° C. to test whether clogging would be an issue. For 45 minutes at 300° C., no clogging was observed. Next, zinc precursor plus cores were run. In batch mode, mixing cores and zinc precursors and heating them together results in InP core blue shift. After waiting 15 minutes (residence time) the cores started to blue shift as expected. Lastly, the sulfur precursor was started. After 15 minutes, the cores red shifted and became luminescent, indicating that a ZnS shell was being formed on the InP nanocrystal cores. Samples were collected over a period of 2 hours of continuous output, where conditions were changed to prepare core shells of different emission wavelengths. InP/ZnS core/shell nanocrystals with four colors ranging from blue to orange were produced by continuous flow synthesis. The colors were visualized under 365 nm UV excitation.

### EXAMPLE 5

### Synthesis of InP Core-ZnS Shell Nanocrystals

Three reactors are placed in series, wherein the output of the first reactor flows into the second reactor, and the output of the second reactor flows into the third reactor.

An indium precursor is prepared by adding indium (III) acetate, oleic acid and squalane that has been purified to remove oxygen and water to a reaction flask under inert atmosphere. The contents of the flask are heated to 260° C. while applying a flow of nitrogen to remove acetic acid that may be formed. After 5 min at 260° C., the flow of nitrogen is stopped. The solution is allowed to cool before drawing the entire contents of the flask into a gastight glass syringe. Next a phosphorus precursor is prepared by adding (TMS)₃P to squalane under inert atmosphere. The resulting phosphorus precursor solution is drawn up into a second gastight glass syringe. Finally, an approprioate volume of squalane is loaded into a third gastight syringe.

First reactor: The three syringes are connected to separate syringe pumps connected to the flow system of the first reactor and the reaction carried out. The reactor is used at a temperature and for a time sufficient to induce nanocrystal nucleation, providing InP seeds.

Second Reactor: The outflow from the first reactor containing the InP seeds in squalane is allowed to flow through the second reactor at a temperature and for a time sufficient to induce nanocrystal growth, providing InP core nanocrystals in squalane. In some embodiments, a weak reductant is added to the reaction mixture to facilitate growth.

Separately, a solution of zinc stearate in squalane is prepared, by pre-heating to above 100° C. to keep the solvent and precursor melt mixed. Sulfur is dispersed in decylamine. The sulfur and zinc precursors are loaded into syringes and mounted on separately controlled syringe pumps connected to the third reactor.

The InP cores in squalane (prepared in the second reactor) are introduced to the third reactor at about 300° C. and the zinc precursors are added via syringe. Lastly, the sulfur precursor is added, and the reaction is monitored until the cores red shift and became luminescent, indicating that a ZnS shell is being formed on the InP nanocrystal cores. After heating for a suitable time, the product is collected.

All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A reactor for use in a continuous flow process, comprising
i. a reactor core, comprising an outer surface and first and second ends; and
ii. a sleeve, comprising an inner surface and a length, said sleeve enclosing a volume;
wherein the core is positioned within the enclosed volume of the sleeve, and the outer surface of the core and the inner surface of the sleeve are spaced apart by a gap distance along the length of the core; and
iii. a reactor tube comprising an outer diameter, a wall, an inner diameter, and an inner tube surface enclosing a reaction tube channel,
wherein the outer diameter of the reactor tube is less than or equal to the gap distance;
wherein the reactor tube is wrapped around the core for at least a portion of the length of the sleeve, and is in thermal contact with at least a portion of the outer surface of the core and optionally a portion of the inner surface of the sleeve along the length of the sleeve; and
iv. the reactor tube further comprises a first and second end, wherein the first end of the reactor tube comprises an inlet in fluid communication with the tube channel, and the second end of the reactor tube comprises an outlet in fluid communication with the tube channel.

2. The reactor of claim 1, wherein the reactor tube comprises stainless steel.

3. The reactor of claim 1, wherein the volume enclosed by the sleeve is cylindrical.

4. The reactor of claim 1, wherein the gap distance is substantially constant.

5. The reactor of claim 1, wherein the outer diameter of the reactor tube is about the same as the gap distance.

6. The reactor of claim 1, wherein the core is cylindrical.

7. The reactor of claim 1, wherein the first end of the reactor tube is positioned near the first end of the core, and the second end of the reactor tube is positioned near the second end of the core.

8. The reactor of claim 1, wherein the length of the sleeve is at least as long as the length of the core.

9. The reactor of claim 1, wherein the reactor comprises a means for heating a reaction mixture in the reactor tube.

10. The reactor claim 1, wherein the reactor tube provides turbulent flow of a reaction mixture in the reaction channel.

11. The reactor of claim 1, wherein the gap distance is about equal to the outer diameter of the reactor tube, and the reactor tube is at least as long as the core.

12. The reactor of claim 1, wherein the core, sleeve and reactor tube are separate components and are adapted so they can be assembled to form the reactor and disassembled.

13. The reactor of claim 1, wherein the sleeve comprises at least two separable pieces that join along the longitudinal axis of the sleeve to form a secure joint, wherein the separable pieces can be assembled around the core having the reactor tube wound around it to enclose the core.

14. A reactor for preparing an inorganic material, comprising the reactor of claim 1, wherein the inorganic material comprises a semiconductor nanocrystal.

15. The reactor of claim 14, which further comprises a reaction mixture containing one or more nanocrystal precursors in the reaction channel.

16. A system for a continuous flow process for the production of an inorganic material, comprising
i. at least one reactor of claim 1;
ii. at least one reservoir for supplying a reaction mixture to the reaction channel; and
iii. a means for collecting the reaction mixture at the outlet.

17. The system of claim 16, wherein the reactor comprises a means for heating.

18. The system of claim 16, which further comprises at least one sensor, wherein the sensor is used to monitor a property of the reaction mixture.

19. The system of any claim 1, wherein the means for collecting the reaction mixture comprises a diverter, wherein the diverter comprises a section of the flow path after the reactor.

20. The system of claim 1, wherein at least the reactor is surrounded by an inert atmosphere.

21. A method of producing nanocrystals in a continuous flow process, comprising introducing a reaction mixture comprising one or more semiconductor nanocrystal precursors into the reactor channel of claim 1, and causing the reaction mixture to flow through the reactor tube, while the reactor tube is heated to a temperature sufficient to induce formation of a semiconductor nanocrystal.

22. The method of claim 21, wherein the reaction mixture comprises at least one saturated precursor in at least one saturated solvent.

23. The method of claim 22, wherein the saturated solvent comprises at least one saturated hydrocarbon, saturated alkylamine, saturated carboxylic acid, or saturated fluorinated solvent, and each saturated hydrocarbon, saturated alkylamine, saturated carboxylic acid, or saturated fluorinated solvent comprises at least 4 carbon atoms.

24. The method of claim 23, wherein the solvent comprises squalane and/or decylamine.

25. The method of claim 21, wherein the precursor comprises a stearate salt.

26. The method of claim 21, wherein the nanocrystal is InP or InAs.

27. A method of producing nanocrystals in a continuous flow process, comprising introducing nanocrystal precursors into the system of claim 16; while heating the reactor to a temperature sufficient to induce nanocrystal formation.

28. A method to produce variable sized nanocrystals in a continuous flow process, comprising the method of claim 21; and further comprising modifying the length or inner diameter of the reaction channel that is in the reactor.

29. The method of claim 28, wherein modifying the length of the reaction channel includes replacing the reactor tube with a shorter or longer reactor tube.

30. The method of claim 29, wherein the reactor tube is replaced with a reactor tube of a different inner diameter.

31. A method to optimize conditions for producing nanocrystals with a flow reactor, comprising:
i) using the method of claim 21 to produce a nanocrystal;
ii) assessing the nanocrystal to determine whether it has a desired property;
iii) modifying at least one reaction parameter selected from residence time, ratio of nanocrystal precursors, concentration of nanocrystal precursors, and reactor temperature;
iv) producing a nanocrystal with the new reaction parameters; and
v) repeating the assessment and modification steps if necessary until a nanocrystal having the desired property is produced.
